(19) United States
(12) Patent Application Publication
(10) Pub. No.: US 2019/0129781 A1
(43) Pub. Date: May 2, 2019

(54) EVENT INVESTIGATION ASSIST METHOD AND EVENT INVESTIGATION ASSIST DEVICE

(71) Applicant: FUJITSU LIMITED, Kawasaki-shi (JP)

(72) Inventors: Tetsuya UCHIUMI, Kawasaki (JP); YUKIHIRO WATANABE, Kawasaki (JP); Masahiro Asaoka, Kawasaki (JP); KAZUHIRO SUZUKI, Kawasaki (JP); Reiko Kondo, Yamato (JP)

(73) Assignee: FUJITSU LIMITED, Kawasaki-shi (JP)

(21) Appl. No.: 16/170,088

(22) Filed: Oct. 25, 2018

(30) Foreign Application Priority Data
Oct. 31, 2017 (JP) 2017-210989

(51) Int. Cl. G06F 11/07; G06N 99/00

(52) U.S. Cl. CPC G06F 11/079; G06F 11/0721; G06N 99/005

(57) ABSTRACT

An event investigation assist device includes a processor. The processor stores a procedure model that associates event information with an investigation procedure and a required time for each of events that occur in a system. The investigation procedure is a procedure for investigating whether the relevant event is a fault. The processor stores a learning model that associates a first reliability with each of investigation contents for each of the events. The investigation contents are included in the investigation procedure. The processor accepts first event information and calculates a second reliability for each of first investigation procedures based on the learning model and the procedure model. The first investigation procedures are associated with the first event information in the procedure model. The processor determines a recommended investigation procedure from among the first investigation procedures based on the second reliability and the required time. The processor displays the recommended investigation procedure.

### CROSS-REFERENCE TO RELATED APPLICATION

This application is based upon and claims the benefit of priority of the prior Japanese Patent Application No. 2017-210989, filed on Oct. 31, 2017, the entire contents of which are incorporated herein by reference.

### FIELD

The embodiments discussed herein are related to an event investigation assist method an event investigation assist device.

### BACKGROUND

In recent years, in order to shorten a time required for a system operator to deal with an alert when an alert occurs in a system such as, for example, an information processing system, a mechanism that acquires and visualizes various pieces of information such as logs, configuration information, and performance information from the system has begun to be distributed. There are various kinds of alerts ranging from a fatal error of a system to a simple status notification. When an alert occurs, the operator acquires various pieces of information from the system and determines whether there is a fault in the system.

However, when the amount of information provided by the system becomes large, an inexperienced operator may not know the procedure and type of information to be acquired to determine whether there is a fault in the system. In other words, an inexperienced operator may not know a procedure of investigation when an alert occurs.

For example, while an alert occurs frequently in the operation of a cloud system, an operator determines the presence or absence of an influence on a service when the alert occurs. In order to determine the presence or absence of the influence on the service, the operator investigates a graph of various resource usage statuses including a CPU use rate, a response time of a storage, and the like. However, an inexperienced operator may not know the procedure and the graph of usage status of resources to be investigated in order to determine the presence or absence of the influence on the service when an alert occurs. Therefore, the investigation procedure of the graph to be performed when an alert occurs is used by preparing the graph based on the past experiences of various operators.

There is an incident management system that visualizes the situations such as a fault influence range in a target system having a configuration in which cloud environments, fault tolerance, or the like is considered. The incident management system has a first function of generating a screen that visualizes the incident situation including the configuration of the target system and the fault influence range using configuration information and incident information, and providing the screen to a terminal of a person in charge. Further, the incident management system also has a second function of setting a configuration including constituent parts designed in consideration of the fault in the target system in the configuration information as a configuration management model.

There is a technique that indicates a sufficiency of monitoring with respect to the target devices and monitoring items in the system. In the technique, a monitoring server receives operation data from the device, causes an administrator terminal to output the received operation data according to a viewpoint instructed from the administrator terminal, and allows a user to monitor the device and the monitoring items by outputting the operation data. In addition, the monitoring server generates a first evaluation value including first information and a first index indicating a sufficiency of monitoring based on the operation data, output setting, an access log, and a first period. Further, the monitoring server generates a second evaluation value including second information and a second index indicating a sufficiency of monitoring based on the first evaluation value, and generates a third evaluation value including third information and a third index indicating the sufficiency of monitoring based on the second evaluation value. In addition, the monitoring server generates data that displays the first, second, and third evaluation values.

There is a fault investigation information apparatus which investigates the fault against a computer fault. The fault investigation information apparatus includes an operating environment setting unit that sets in advance an operating environment for a fault investigation in a setting table, a log collection unit that collects investigation information in accordance with the contents of the setting table when a fault occurs, and a trace collection unit that collects trace information at the time of designating the operation. Further, the fault investigation information apparatus includes an investigation information recording unit that outputs the investigation information collected by the log collection unit and the trace collection unit to a storage medium according to the contents of the setting table.

Related techniques are disclosed in, for example, Japanese Laid-Open Patent Publication No. 20012-038028, Japanese Laid-Open Patent Publication No. 2012-238213, and Japanese Laid-Open Patent Publication No. 10-260861.

### SUMMARY

According to an aspect of the present invention, provided is an event investigation assist device including a memory and a processor coupled to the memory. The processor is configured to store a procedure model in the memory. The procedure model associates event information with an investigation procedure and a required time for each of events that occur in a system. The event information is information regarding a relevant event. The investigation procedure is a procedure for investigating whether the relevant event is a fault. The required time is a time spent for performing investigation in accordance with the investigation procedure. The processor is configured to store a learning model in the memory. The learning model associates a first reliability with each of investigation contents for each of the events. The investigation contents are included in the investigation procedure. The processor is configured to accept first event information. The processor is configured to calculate a second reliability for each of first investigation procedures based on the learning model and the procedure model. The first investigation procedures are associated with the first event information in the procedure model. The processor is configured to determine a recommended investigation procedure from among the first investigation procedures based on the second reliability and the required time. The processor is configured to display the recommended investigation procedure.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram for describing an outline of an event investigation assist device according to a first embodiment;

FIG. 2 is a diagram illustrating an example of a search expression;

FIGS. 3A and 3B are diagrams illustrating a difference between an investigation in the related art and an investigation using the event investigation assist device according to the first embodiment;

FIG. 4 is a diagram illustrating a functional configuration of the event investigation assist device according to the first embodiment;

FIG. 5 is a diagram illustrating an example of an alert investigation history;

FIG. 6 is a diagram illustrating an example of a procedure model;

FIG. 7 is a diagram illustrating an example of a learning model;

FIG. 8 is a flowchart illustrating a flow of processing from preprocessing up to learning;

FIG. 9 is a flowchart illustrating a flow of processing from use up to evaluation;

FIG. 10 is a flowchart illustrating a flow of processing by an application procedure estimation unit;

FIG. 11 is a diagram illustrating an example of an alert investigation history;

FIG. 12 is a diagram illustrating an example of data extracted from an investigation history storage unit for each alert class;

FIG. 13 is a diagram illustrating an example of a procedure model;

FIG. 14 is a diagram illustrating a calculation example of reliability;

FIGS. 15A and 15B are diagrams illustrating a learning model and a procedure model which are extracted;

FIGS. 16A and 16B are diagrams illustrating the reliability and the score of the procedure model;

FIGS. 17A and 17B are diagrams illustrating the procedure model added to a procedure model storage unit;

FIGS. 18A and 18B are diagrams illustrating an update result of the learning model;

FIGS. 19A to 19C are diagrams for describing a negative evaluation;

FIG. 20 is a diagram illustrating a functional configuration of an event investigation assist device according to a second embodiment;

FIG. 21 is a diagram illustrating an example of an operation engagement history;

FIG. 22 is a diagram illustrating an operator reliability calculated from the operation engagement history illustrated in FIG. 21;

FIGS. 23A and 23B are diagrams illustrating examples of a reliability and a learning model for each search expression group application procedure for each procedure model;

FIG. 24 is a flowchart illustrating a flow of processing from preprocessing up to learning;

FIGS. 25A and 25B are diagrams illustrating the learning model and the procedure model extracted by the procedure extraction unit of the event investigation assist device;

FIGS. 26A and 26B are diagrams illustrating the reliability and the score of the procedure model;

FIGS. 27A and 27B are diagrams illustrating the procedure model added to a procedure model storage unit;

FIGS. 28A and 28B are diagrams illustrating an update result of the learning model;

FIGS. 29A to 29C are diagrams for describing a negative evaluation; and

FIG. 30 is a diagram illustrating a hardware configuration of a computer that executes an event investigation assist program according to an embodiment.

### DESCRIPTION OF EMBODIMENTS

There is a possibility that an investigation procedure may be generated with a low reliability in a technique of generating and using the investigation procedure of a graph at the time of an occurrence of an alert based on various past experiences of an operator, which is problematic. When an experienced operator generates an investigation procedure, the investigation procedure may not be efficient and the reliability of the investigation procedure may become low.

Hereinafter, embodiments will be described in detail with reference to the accompanying drawings. Further, the embodiments do not limit a disclosed technology.

### First Embodiment

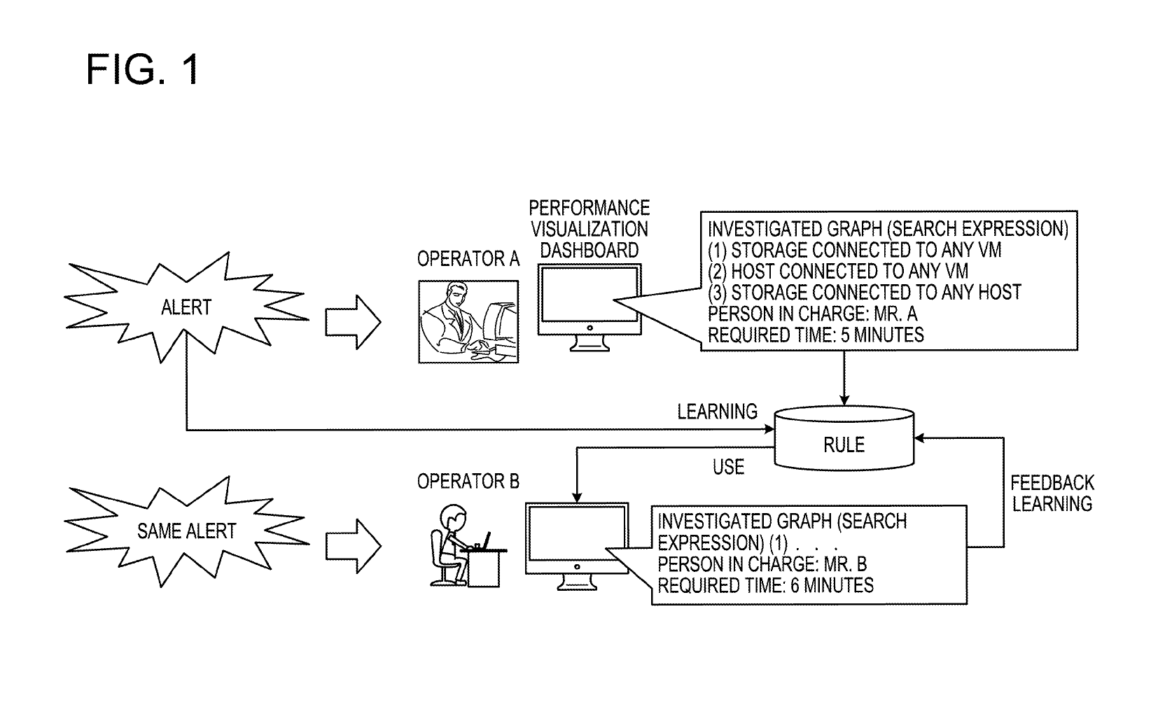

First, an outline of an event investigation assist device according to a first embodiment will be described. FIG. 1 is a diagram for describing an outline of an event investigation assist device according to a first embodiment. As illustrated in FIG. 1, the event investigation assist device according to the first embodiment links the alert information with the graphs displayed on a performance visualization dashboard by an operator when an alert had occurred in the past, and makes a rule to be learned. Here, the performance visualization dashboard is a screen that visualizes and displays the performance of a cloud system.

In FIG. 1, when an alert occurs, operator A displays a graph representing the performance of a storage associated with a predetermined virtual machine (VM), a graph representing the performance of a host associated with a predetermined VM, and a graph representing the performance of a storage associated with a predetermined host to investigate whether an influence is exerted onto the service. Here, there is, for example, a response time as for the performance of the storage, and there is, for example, a CPU usage rate as for the performance of the host. Further, the required time (a time required for response) is, for example, about 5 minutes.

The event investigation assist device according to the first embodiment makes a rule for the alert information in association with three graphs and the investigation time. The event investigation assist device according to the first embodiment learns a plurality of rules generated by a plurality of operators regarding the same alert.

Then, when the similar alert occurs, the event investigation assist device according to the first embodiment displays the graph and a procedure to be investigated using a learning result. Operator B performs an investigation by referring to the investigation procedure displayed by the event investigation assist device according to the first embodiment and determines whether there is the influence on the service. Operator B may perform the investigation according to a different investigation procedure from a case of performing the investigation according to the investigation procedure displayed by the event investigation assist device according to the first embodiment. In addition, the event investigation assist device according to the first embodiment feeds back and learns the investigation procedure and the investigation time by operator B.

As described above, the event investigation assist device according to the first embodiment learns and uses the investigation procedure and the investigation time by the operator when the alert occurs. Further, the graph is displayed by searching a database that stores performance data of a resource of the cloud system. Accordingly, a search expression of the database corresponds to the graph.

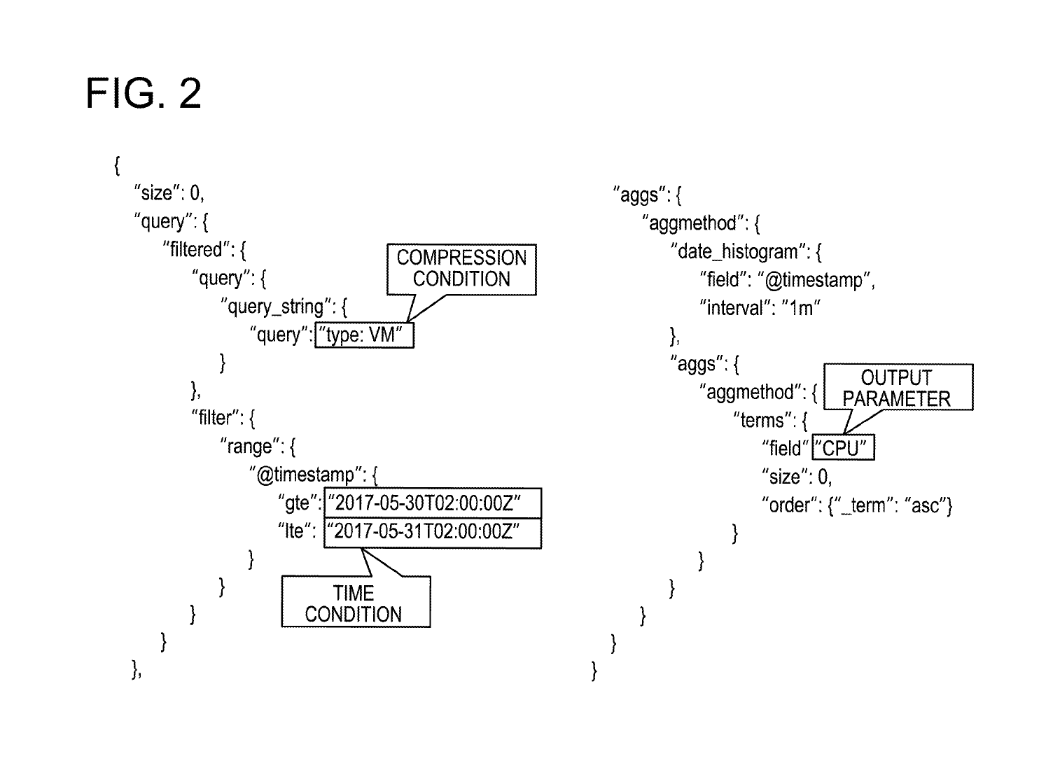

FIG. 2 is a diagram illustrating an example of a search expression. FIG. 2 illustrates a case where the CPU usage rate of the VM is searched from 2 o'clock on May 30, 2017 to 2 o'clock on May 31. The search expression corresponds to a graph in which the CPU usage rate of the VM is displayed from 2 o'clock on May 30, 2017 to 2 o'clock on May 31. Therefore, the event investigation assist device according to the first embodiment treats the graph as the search expression. Further, in FIG. 2, “VM” is designated as a compression condition, “CPU” is designated as an output parameter, and “from 2 o'clock on May 30, 2017 to 2 o'clock on May 31^{st}” is designated as a time condition.

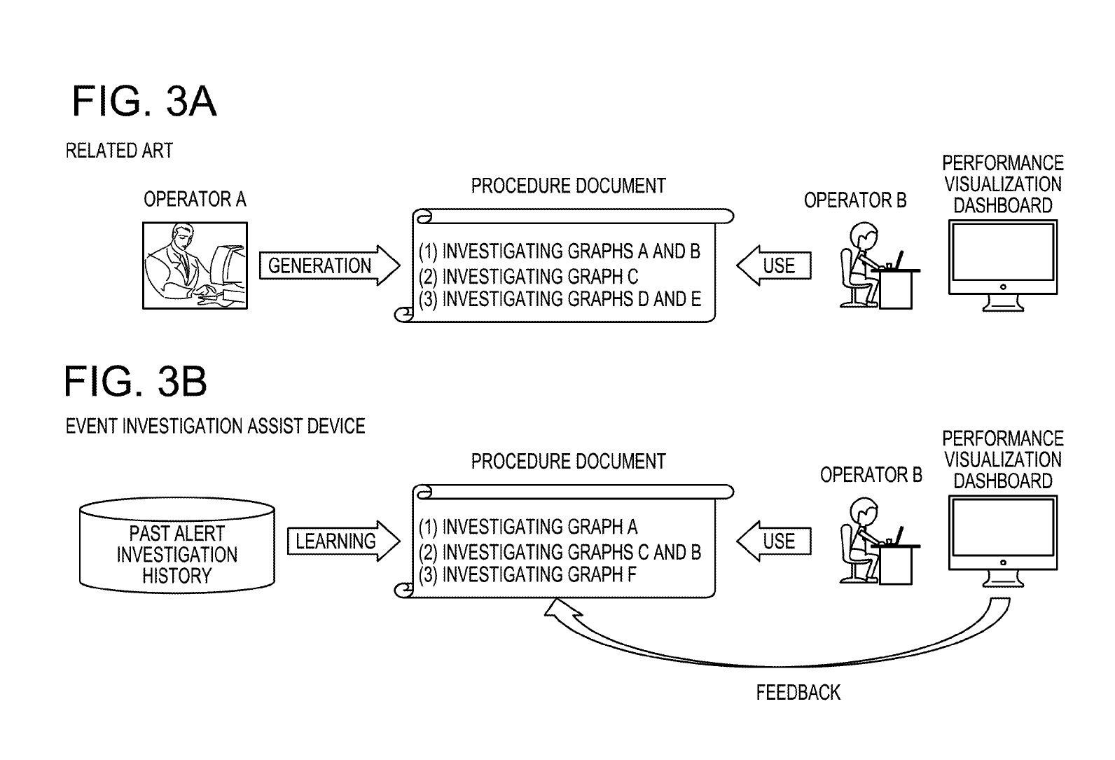

FIGS. 3A and 3B are diagrams illustrating a difference between an investigation in the related art and an investigation using the event investigation assist device according to the first embodiment. As illustrated in FIG. 3A, in the related art, operator A generates a procedure document representing the procedure of the investigation when the alert occurs and another operator B uses the procedure document generated by operator A. The procedure document designates, for example, that graphs A and B are investigated, graph C is then investigated, and then, graphs D and E are investigated.

In the meantime, as illustrated in FIG. 3B, the event investigation assist device according to the first embodiment learns a past alert investigation history and generates the procedure document. In addition, operator B performs an investigation by using the procedure document generated by the event investigation assist device according to the first embodiment. In addition, the event investigation assist device according to the first embodiment feeds back the investigation procedure of operator B.

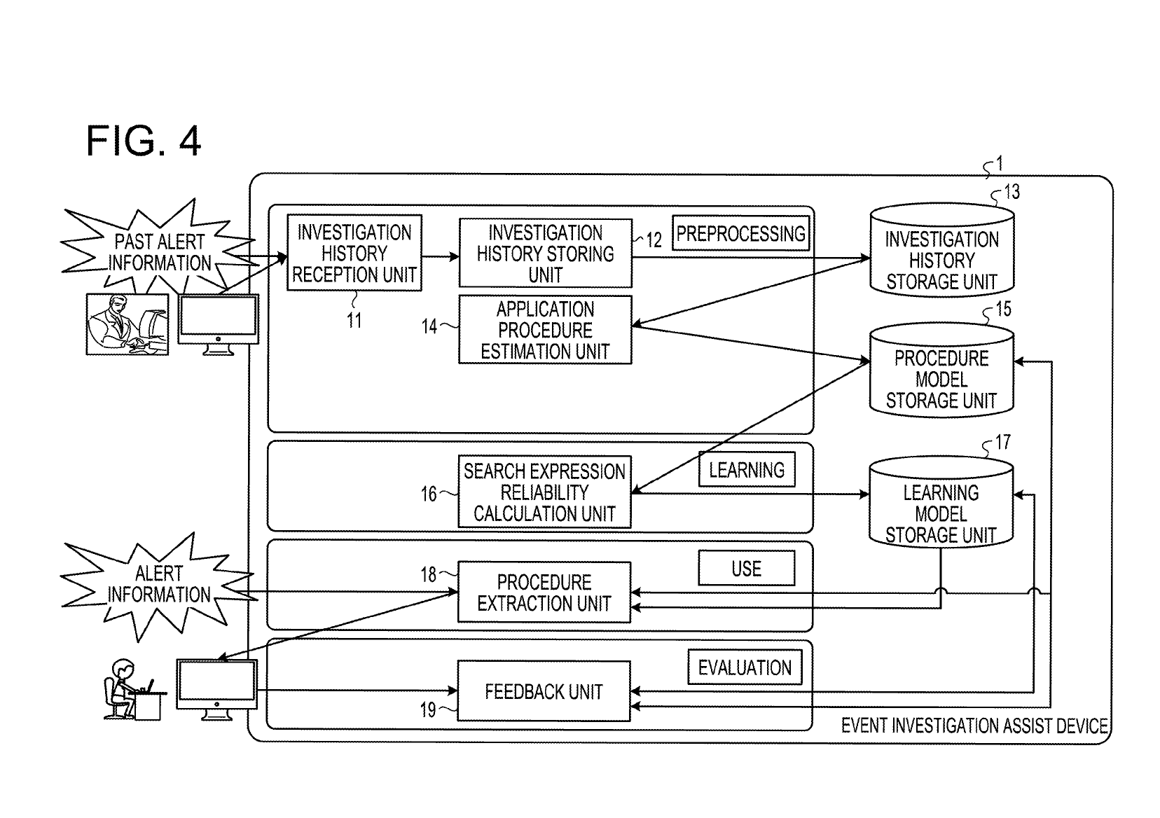

Next, a functional configuration of the event investigation assist device according to the first embodiment will be described. FIG. 4 is a diagram illustrating a functional configuration of the event investigation assist device according to the first embodiment. As illustrated in FIG. 4, the event investigation assist device 1 according to the first embodiment includes an investigation history reception unit 11, an investigation history storing unit 12, an investigation history storage unit 13, an application procedure estimation unit 14, a procedure model storage unit 15, a search expression reliability calculation unit 16, and a learning model storage unit 17. Further, the event investigation assist device 1 includes a procedure extraction unit 18 and a feedback unit 19.

The investigation history reception unit 11 receives past alert information. The investigation history storing unit 12 stores the alert investigation history received by the investigation history reception unit 11 in the investigation history storage unit 13. The investigation history storage unit 13 stores the alert investigation history.

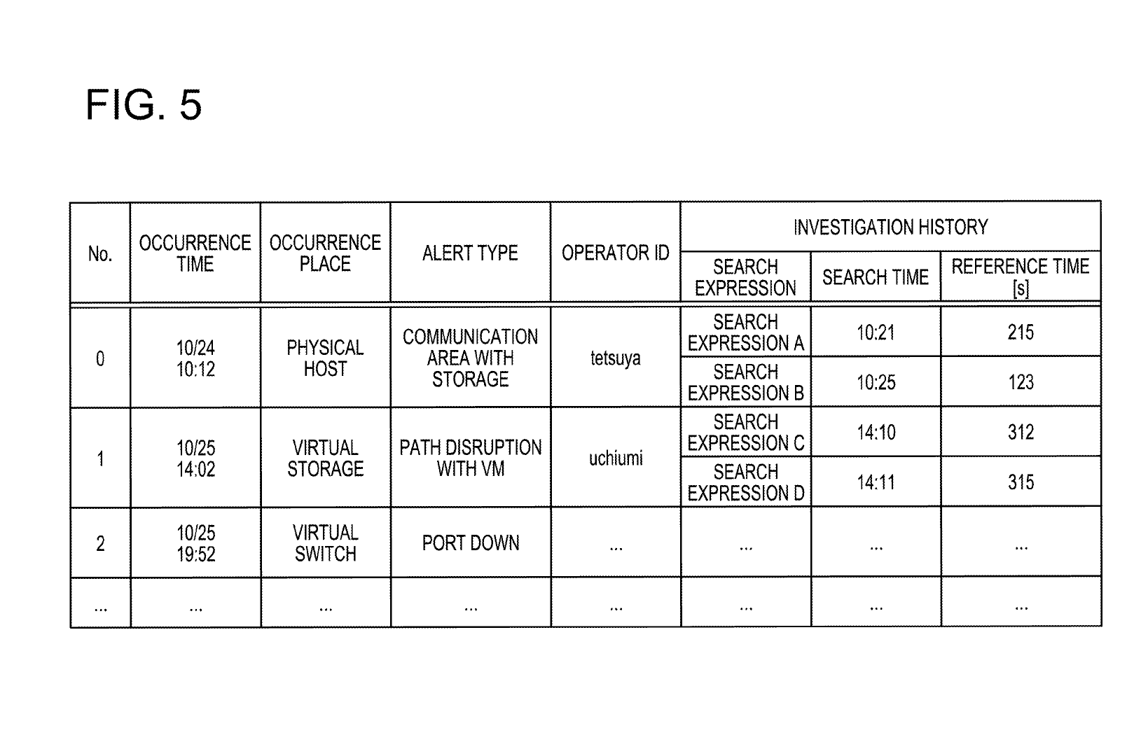

FIG. 5 is a diagram illustrating an example of an alert investigation history. As illustrated in FIG. 5, each alert investigation history includes No., an occurrence time, an occurrence place, an alert type, an operator ID, and an investigation history.

The symbol “No.” represents a number which identifies the alert investigation history. The occurrence time represents a date and time when the alert occurs. The occurrence place represents a place where the alert occurs in the cloud system. The alert type represents a type of alert. Here, the occurrence place and the alert type are collectively referred to as an alert class. The operator ID represents an identifier which identifies the operator that performs the investigation for the alert.

The investigation history is information on the investigation item and the investigation time. The investigation history includes the search expression, a search time, and a reference time. The search expression is a search expression which the operator uses to display the graph and is the investigation item. The search time represents a time when the operator inputs the search expression. The reference time represents a time when the operator refers to the graph and represents a time when the graph is displayed on a screen. A unit of the reference time is second (s). One investigation history includes one or more combinations of the search expression, the search time, and the reference time.

For example, an alert identified by “0” occurs at “10/24 10:12”, the occurrence place is “physical host”, the alert type is “communication delay with the storage”, and the alert is investigated according to “tetsuya”. “tetsuya” displays a graph on “10:21” using “search expression A”, refers to “215 seconds”, displays a graph at “10:25” using “search expression B”, and refers to “123” seconds.

The application procedure estimation unit 14 estimates the search expression, the procedure, and the investigation time which the operator uses for the investigation from the investigation history for each alert investigation history to generate a procedure model. In this case, the application procedure estimation unit 14 sets the search expressions corresponding to the graphs which the operator may estimate simultaneously watching in the same procedure. The application procedure estimation unit 14 estimates that the operator simultaneously watches the graphs when there is an overlap exceeding a predetermined threshold at a time displayed between the graphs referred to by the operator.

The application procedure estimation unit 14 estimates a time required by the operator for the investigation (required time) based on a first search time, a last search time, and the reference time. In addition, the application procedure estimation unit 14 stores the generated procedure model in the procedure model storage unit 15. The procedure model storage unit 15 stores the procedure model.

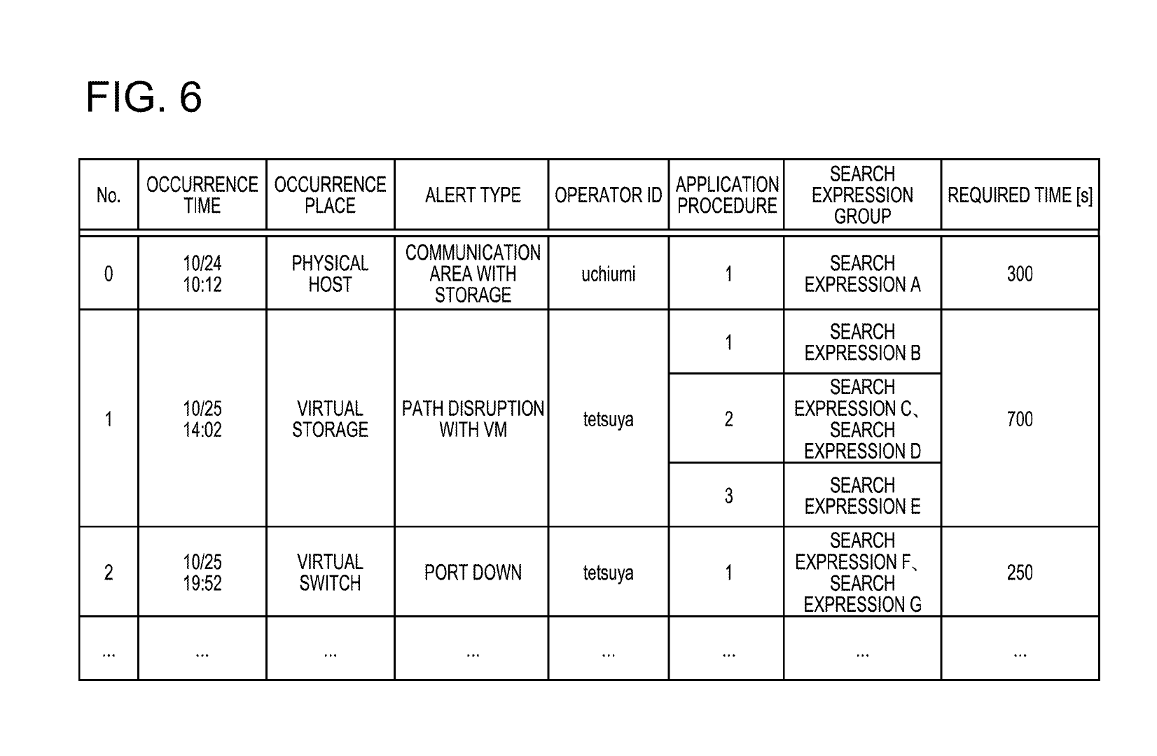

FIG. 6 is a diagram illustrating an example of the procedure model. As illustrated in FIG. 6, each procedure model includes No., the occurrence time, the occurrence place, the alert type, the operator ID, the application procedure, the search expression group, and the required time.

The symbol “No.” represents a number which identifies the procedure model. The occurrence time represents a date and time when the alert corresponding to the procedure model occurs. The occurrence place represents a place where the alert corresponding to the procedure model occurs in the cloud system. The alert type represents a type of alert corresponding to the procedure model. The operator ID represents an identifier which identifies the operator that performs the investigation according to the investigation procedure of the procedure model.

The investigation procedure is one or more sets of the application procedure and the search expression group. The application procedure is a procedure of investigation contents in the investigation procedure, that is, the investigation procedure. The search expression group is one or more search expressions which the operator uses to display one or more graphs and is the investigation contents. The required time is a time which the operator requires for the investigation. A unit of the required time is second (s).

For example, in a procedure model identified by “1”, a type which occurs in a “virtual storage” at “10/25 14:02” corresponds to an alarm which is “path disruption with VM”, and the alert is investigated by “tetsuya”. In “tetsuya”, the graph is first displayed by using “search expression B”, two graphs are then displayed by using “search expression C” and “search expression D”, and then, the graph is displayed by using “search expression E”. A time which “tetsuya” requires for the investigation is “700” seconds.

The search expression reliability calculation unit 16 calculates the number of times of use for one or more procedure models for each alert class for each search expression application procedure and generates the learning model by using the calculated number of times as reliability of a search expression group in the application procedure. Here, the search expression group application procedure is for each search expression group and for each application procedure. In addition, the search expression reliability calculation unit 16 stores the generated learning model in the learning model storage unit 17. The learning model storage unit 17 stores the learning model.

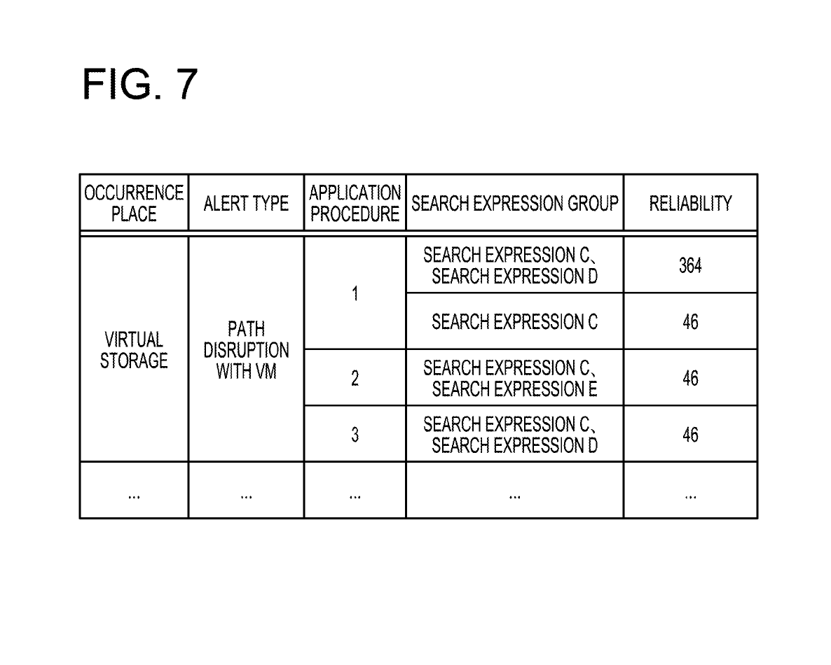

FIG. 7 is a diagram illustrating an example of a learning model. As illustrated in FIG. 7, each learning model includes the occurrence place, the alert type, the application procedure, the search expression group, and the reliability. A combination of the occurrence place and the alert type indicates the alert class. The application procedure is a procedure in which the search expression group is used in the investigation procedure. The reliability is the number of times of use of the search expression group for each search expression group application procedure. As the number of times of use of the same search expression group in the same procedure increases, the reliability increases. That is, the reliability becomes higher as more operators look at the same graph in the same procedure.

For example, when “path disruption with VM” occurs in “virtual storage”, “search expression C” and “search expression D” are used first, the reliability is “364”. “search expression C” is used first and the reliability is “46”.

The procedure extraction unit 18 accepts alert information from the operator, acquires the learning model and the procedure model associated with the alert class, and applies the learning model to the procedure model to calculate the reliability of each procedure model. In addition, the procedure extraction unit 18 calculates a score obtained by dividing the reliability by the required time for each procedure model and displays the procedure model having a highest score on a display device as a recommended investigation procedure. As more operators use the procedure model, the investigation time becomes shorter, and the score becomes higher. Further, the procedure model and the learning model correspond to the rule illustrated in FIG. 1.

The feedback unit 19 accepts the investigation procedure and the investigation time in which the operator actually performs the investigation based on the recommended investigation procedure, updates the procedure model storage unit 15 at the accepted investigation procedure and investigation time, and updates the learning model storage unit 17 by using the updated procedure model storage unit 15. Further, the feedback unit 19 may accept the alert investigation history from the operator.

In the case where the accepted investigation procedure is the same as the recommended investigation procedure, the feedback unit 19 increases the reliability of the learning model and when the accepted investigation procedure is different from the recommended investigation procedure, the reliability of the learning model corresponding to the application procedure in which the search expression group is different in the recommended investigation procedure is reduced. The feedback unit 19 accepts a weight used when increasing or decreasing the reliability, and increases or decreases a value multiplied by the weight. The details of updating the learning model will be described below using an example.

The investigation history reception unit 11, the investigation history storing unit 12, and the application procedure estimation unit 14 generate the procedure model by performing preprocessing. The search expression reliability calculation unit 16 learns the procedure model and generates the learning model. The procedure extraction unit 18 specifies the recommended investigation procedure using the learning model and displays the specified recommended investigation procedure. The feedback unit 19 updates the procedure model and the learning model based on the evaluation by the operator of the recommended investigation procedure.

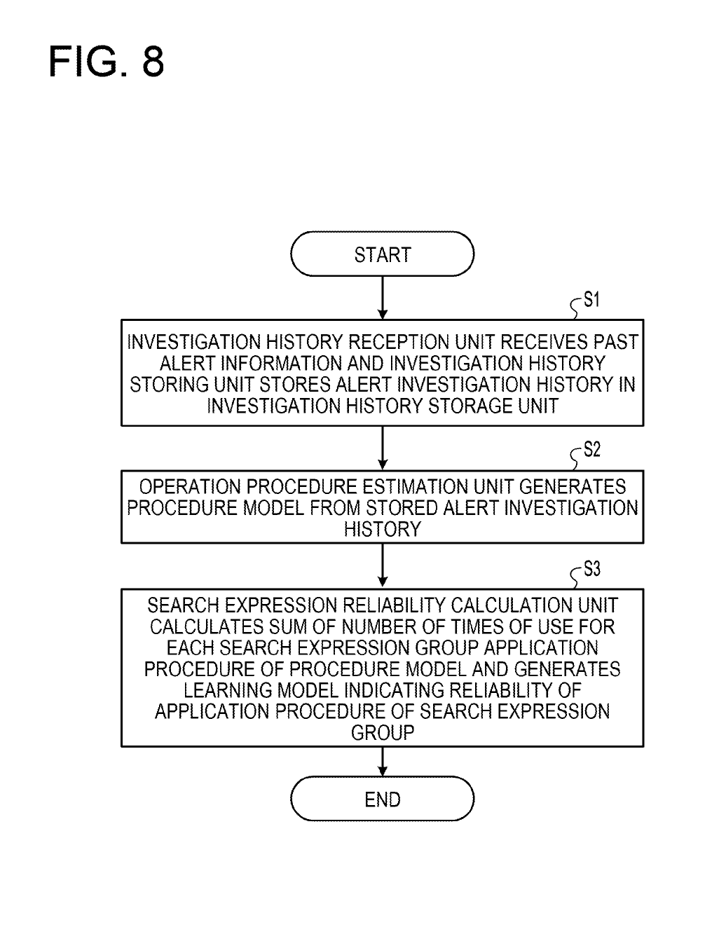

Next, a flow of processing by the event investigation assist device 1 will be described. FIG. 8 is a flowchart illustrating a flow of processing from preprocessing up to learning. As illustrated in FIG. 8, the investigation history reception unit 11 receives the past alert information and the investigation history storing unit 12 stores the alert investigation history in the investigation history storage unit 13 (step S1).

In addition, the application procedure estimation unit 14 generates the procedure model from the stored alert investigation history (step S2). Further, the search expression reliability calculation unit 16 calculates the sum of the number of times of use of the procedure model for each search expression group application procedure and generates the learning model representing the reliability for each application procedure of the search expression group (step S3).

As described above, the application procedure estimation unit 14 generates the procedure model and the search expression reliability calculation unit 16 generates a learning model representing the reliability for each application procedure of the search expression group, so that the event investigation assist device 1 may specify and display the recommended investigation procedure.

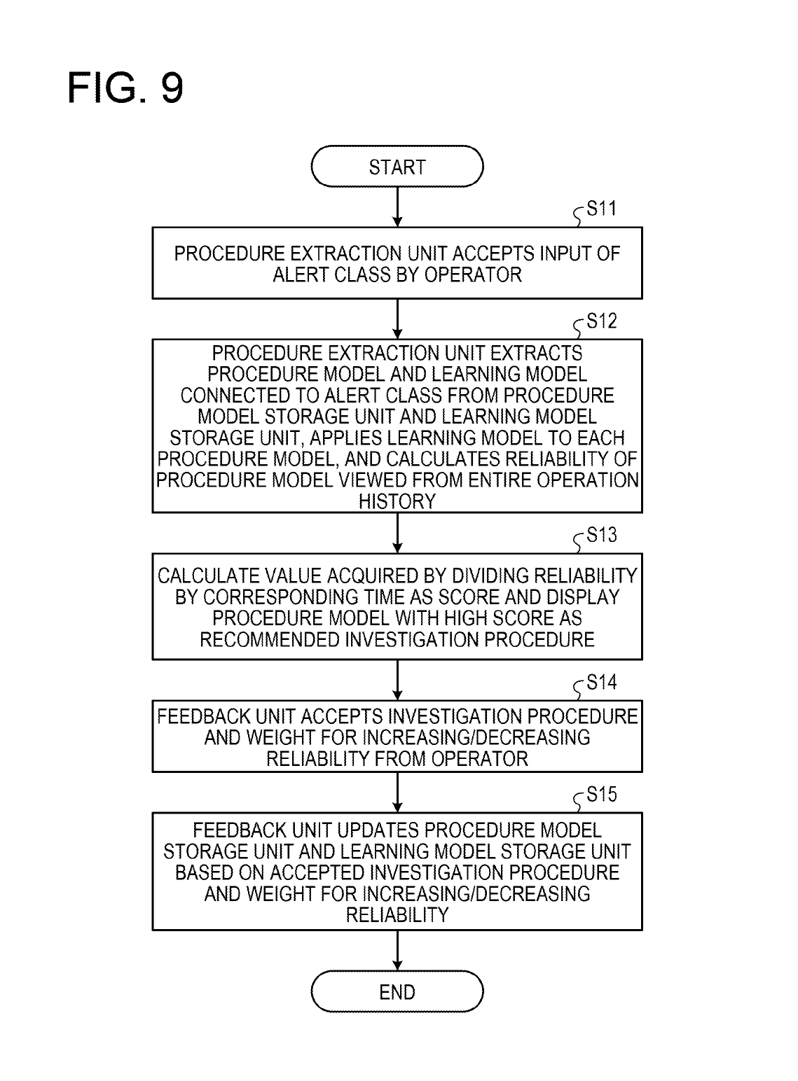

FIG. 9 is a flowchart illustrating a flow of processing from use up to evaluation. As illustrated in FIG. 9, the procedure extraction unit 18 accepts the input of the alert class by the operator (step S11). In addition, the procedure extraction unit 18 extracts the procedure model and the learning model connected for each alert class from the procedure model storage unit 15 and the learning model storage unit 17, and applies the learning model to each procedure model to calculate the reliability of the procedure model based on an entire operation history (step S12). Further, the procedure extraction unit 18 calculates a value acquired by dividing the reliability by the required time as a score and displays the procedure model having a higher score as the recommended investigation procedure (step S13).

The feedback unit 19 accepts the investigation procedure performed based on the recommended investigation procedure and the weight for increasing/decreasing the reliability from the operator (step S14). Moreover, the feedback unit 19 updates the procedure model storage unit 15 and the learning model storage unit 17 based on the received investigation procedure and weight for increasing/decreasing the reliability (step S15).

As described above, the procedure extraction unit 18 calculates the reliability of each procedure model and calculates the score by dividing the calculated reliability by the required time, and as a result, the event investigation assist device 1 may specify and display the recommended investigation procedure.

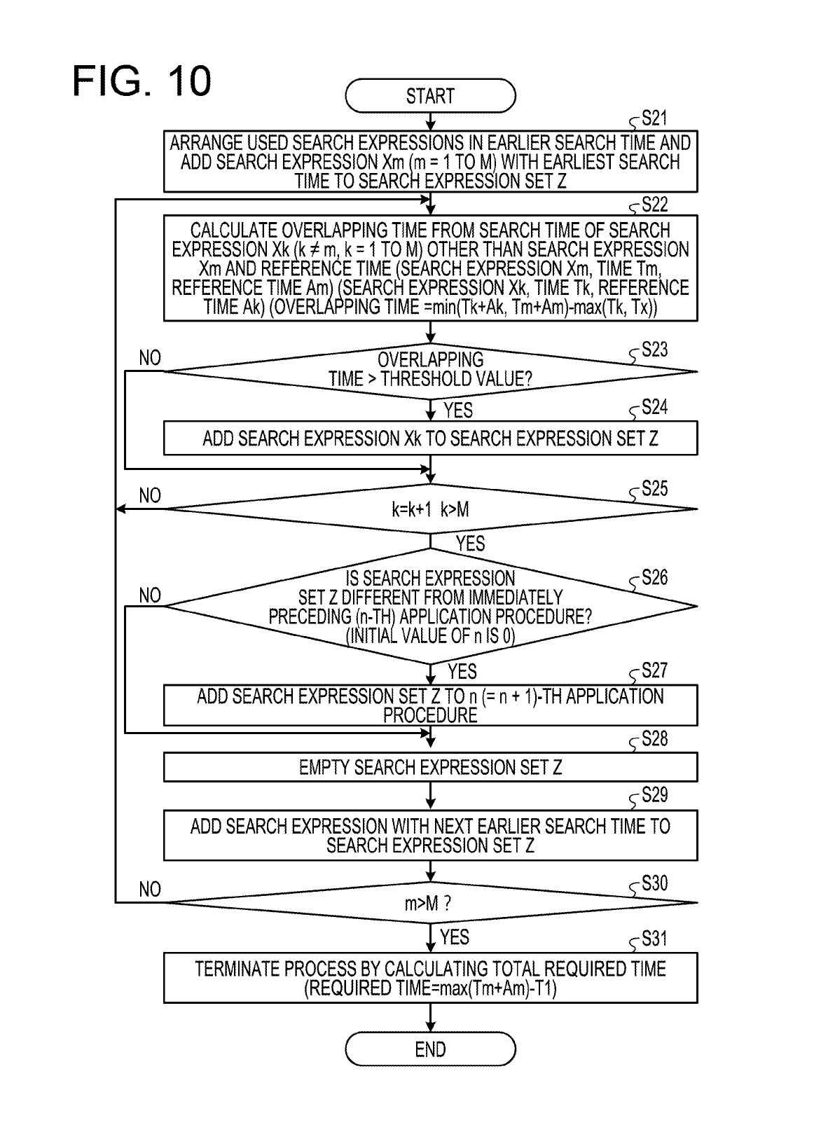

FIG. 10 is a flowchart illustrating a flow of processing by the application procedure estimation unit 14. As illustrated in FIG. 10, the application procedure estimation unit 14 arranges the used search expressions in procedure of an earlier search time and adds the search expression Xm (m=1 to M) having the earliest search time to a search expression set Z (step S21).

The application procedure estimation unit 14 calculates an overlap time from the search time of a search expression Xk (k≠m, k=1 to M) different from the search expression Xm and the reference time (step S22). The overlapping time=min (Tk+Ak, Tm+Am)−max (Tk, Tx) when the search time of the search expression Xm is Tm, the reference time is Am, the search time of the search expression Xk is Tk, and the reference time is Ak.

The application procedure estimation unit 14 determines whether the overlapping time is greater than a threshold value (step S23) and when the overlapping time is greater than the threshold value, the application procedure estimation unit 14 adds the search expression Xk to the search expression set Z (step S24). Further, the application procedure estimation unit 14 adds 1 to k and determines whether k is larger than M (step S25). When k is not greater than M, the process returns to step S22.

Meanwhile, when k is greater than M, the application procedure estimation unit 14 determines whether the search expression set Z is different from an immediately preceding (n-th) application procedure (step S26). Here, an initial value of n is 0. In addition, when the search expression set Z is different from the immediately preceding (n-th) application procedure, 1 is added to n and the search expression set Z is added in the n-th application procedure (step S27).

The application procedure estimation unit 14 empties the search expression set Z (step S28), adds 1 to m, and adds the search expression Xm having a next earlier search time to a search set (step S29). Moreover, the application procedure estimation unit 14 determines whether m is larger than M (step S30). When m is not larger than M, the process returns to step S22 and when m is larger M, a total required time is calculated and the process ends (step S31). Here the required time=max(Tm+Am)−T1.

As described above, the application procedure estimation unit 14 may generate the procedure model by specifying the search expression having the same application procedure and calculating the required time.

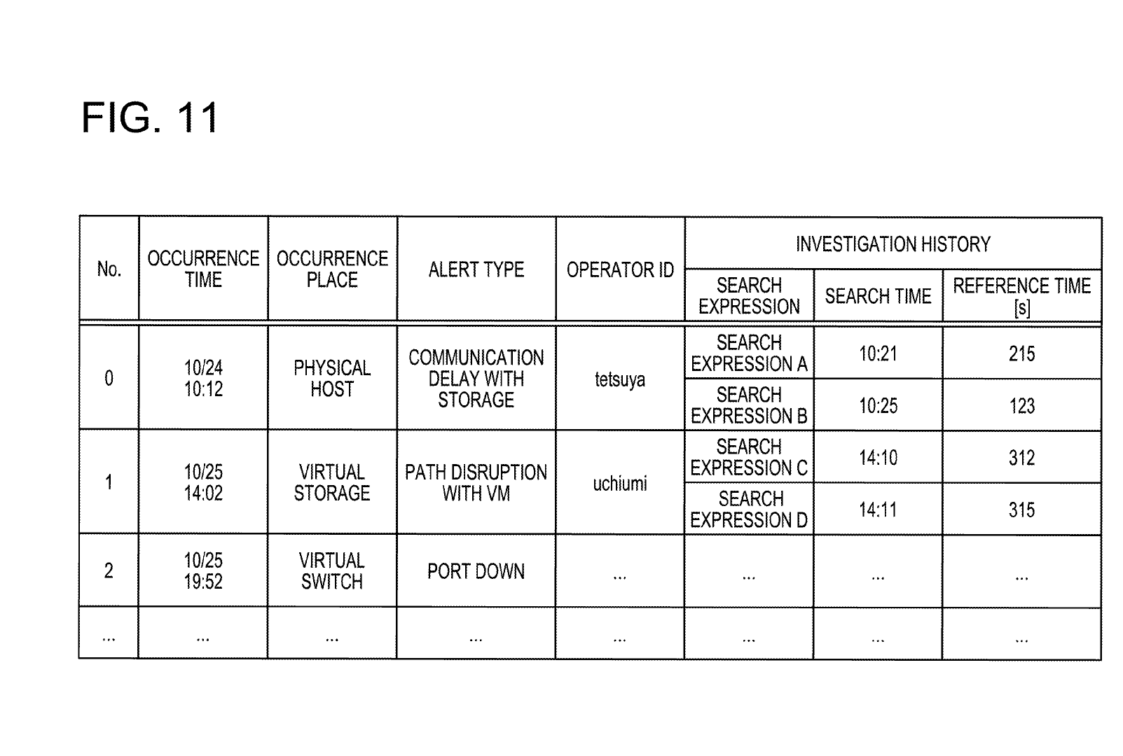

Next, an example by the event investigation assist device 1 will be described with reference to FIGS. 11 to 19. FIG. 11 is a diagram illustrating an example of an alert investigation history. As illustrated in FIG. 11, the alert investigation history includes the occurrence time, the alert class (occurrence place and alert type), the operator ID, and the investigation history.

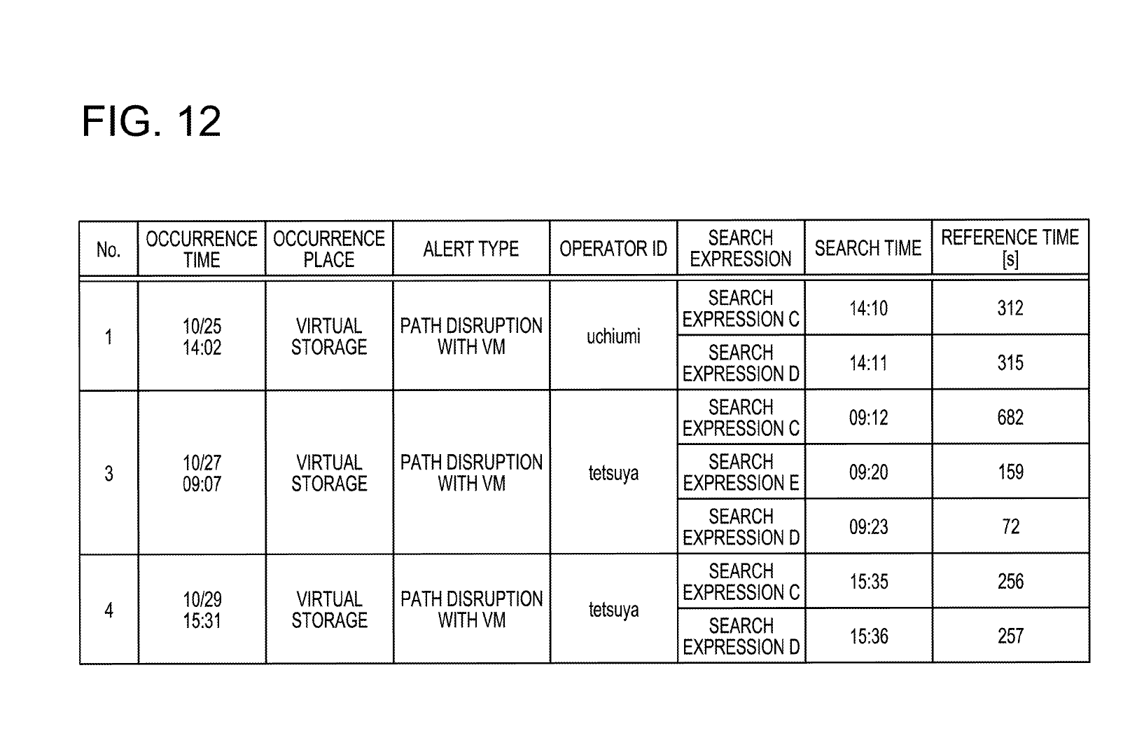

The application procedure estimation unit 14 extracts data related to each alert class from the investigation history storage unit 13. FIG. 12 is a diagram illustrating an example of data extracted from the investigation history storage unit 13 for each alert class. FIG. 12 illustrates an example of data extracted from the investigation history storage unit 13 regarding an alert class in which the occurrence place is “virtual storage” and the alert type is “path disruption with VM”.

The application procedure estimation unit 14 estimates the application procedure of the search expression group based on the search time and the reference time. The application procedure estimation unit 14 estimates that the operator refers to the plurality of graphs at the same time and determines that the application procedures of the plurality of search expressions are the same when the time overlapped and displayed among the plurality of graphs is larger than a predetermined threshold value. Further, the application procedure estimation unit 14 estimates the required time based on a first search time, a last search time, and the reference time. In addition, the application procedure estimation unit 14 generates the procedure model and stores the procedure model in the procedure model storage unit 15.

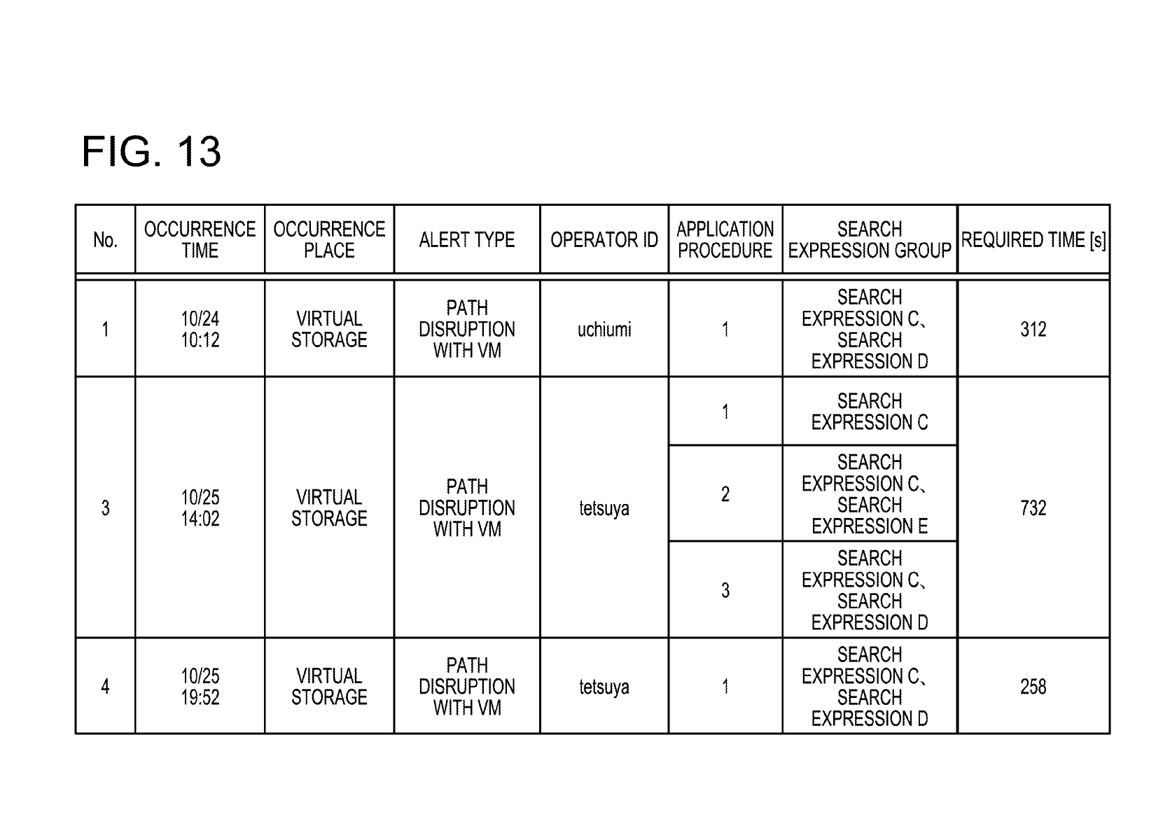

FIG. 13 is a diagram illustrating an example of a procedure model. In FIG. 13, for example, in the investigation of “uchiumi”, it is estimated that “search expression C and search expression D” are used for simultaneous reference and the application procedure of both the search expressions is set to “1”.

The search expression reliability calculation unit 16 calculates the sum of the number of times of use for each search expression group to calculate the reliability for each application procedure of the procedure model. In addition, the search expression reliability calculation unit 16 generates the learning model and stores the generated learning model in the learning model storage unit 17.

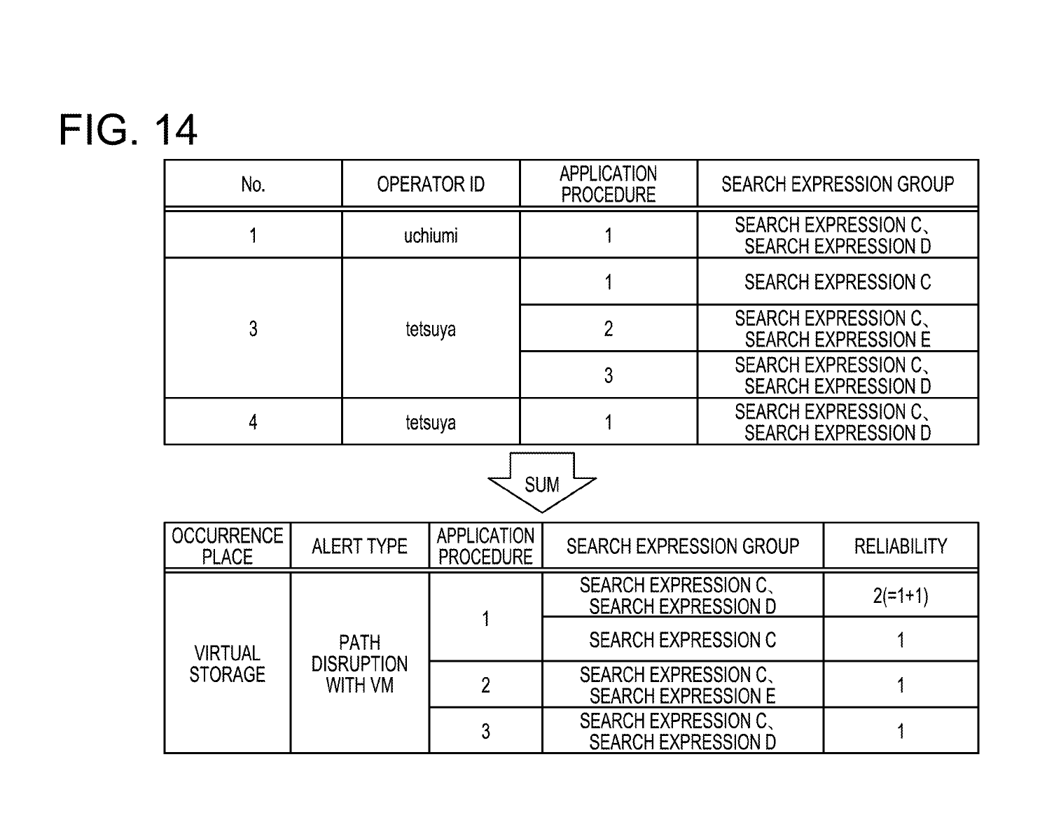

FIG. 14 is a diagram illustrating a calculation example of reliability. For example, there are two procedure models in which the application procedure is “1” and the search expression group is “search expression C” and “search expression D”. Therefore, as to the alert class in which the occurrence place is “virtual storage” and the alert type is “path disruption with VM”, when the application procedure is “1” and the search expression group is “search expression C and search expression D”, reliability is “2”.

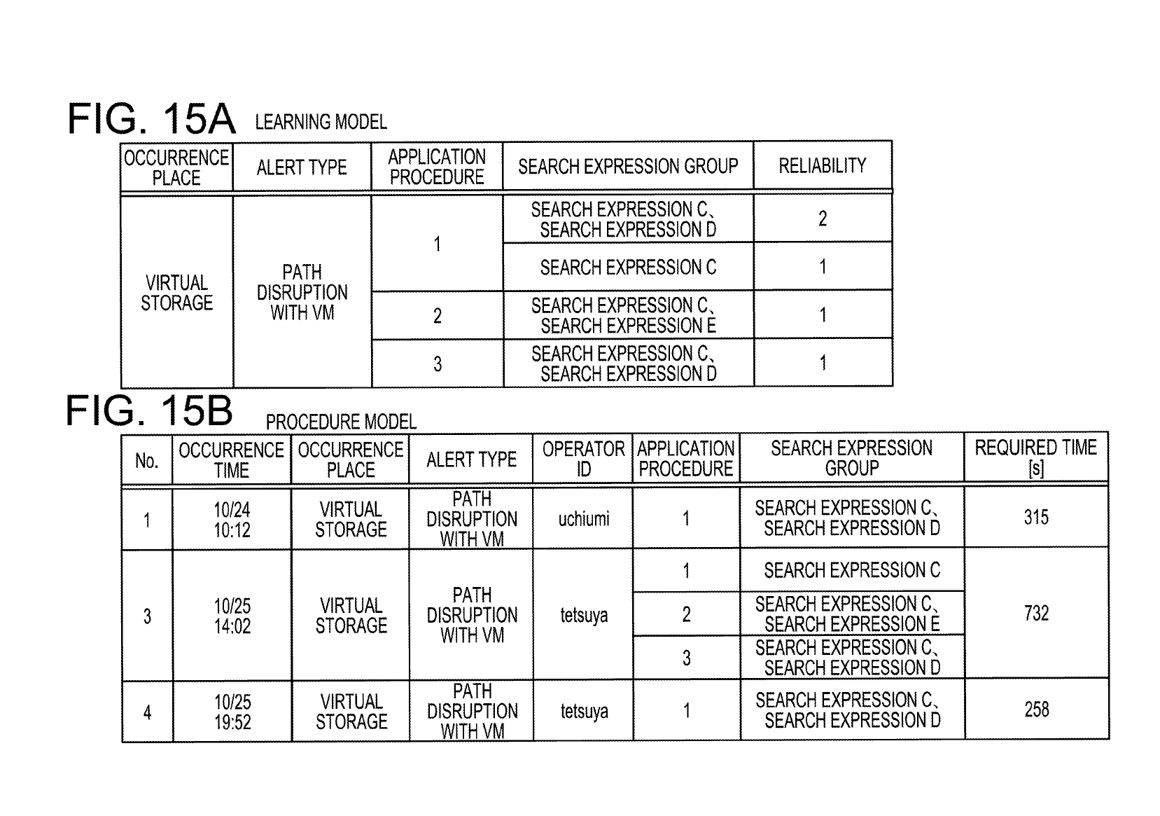

The procedure extraction unit 18 extracts the learning model and the procedure model relating to the alert class of the occurring alert from the learning model storage unit 17 and the procedure model storage unit 15, respectively. FIGS. 15A and 15B are diagrams illustrating the extracted learning model and procedure model. FIG. 15A illustrates the learning model and FIG. 15B illustrates the procedure model. In FIGS. 15A and 15B, the learning model and the procedure model are extracted as to the alert class in which the occurrence place is “virtual storage” and the alert type is “path disruption with VM”.

The procedure extraction unit 18 applies the learning model to each procedure model to calculate the reliability of each procedure model and calculates the score of each procedure model by dividing the calculated reliability by the required time. Here, applying the learning model to each procedure model indicates setting the reliability for each search expression group application procedure of the learning model as the reliability for each search expression group application procedure of the procedure model.

When the application procedure of the procedure model is only “1”, the reliability of the application procedure “1” of the procedure model is the reliability of the procedure model and when the application procedure of the procedure model is plural, the sum of the reliability for each application procedure of the procedure model is the reliability of the procedure model.

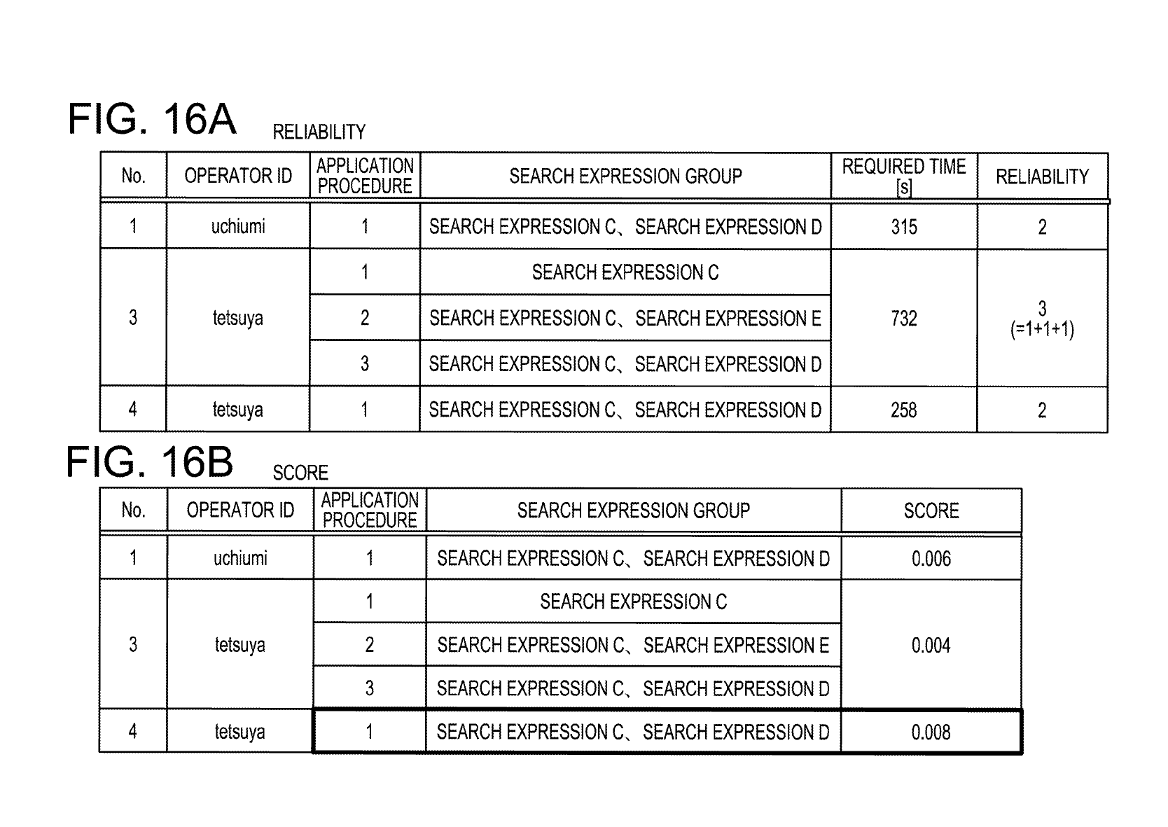

FIGS. 16A and 16B are diagrams illustrating the reliability and the score of the procedure model. FIG. 16A illustrates the reliability and FIG. 16B illustrates the score. For example, as illustrated in FIG. 15A, the reliability of the search expression group “search expression C” in the application procedure “1” of procedure model No. 3 is “1”, the reliability of the search expression group “search expression C and search expression E” in the application procedure “2” is “1”, and the reliability of the search expression group “search expression C and search expression D” in the application procedure “3” is “1”. Therefore, as illustrated in FIG. 16A, the reliability of procedure model No. 3 is “1”+“1”+“1”=“3”. Further, as illustrated in FIG. 16B, the score of procedure model No. 3 is “3”÷“732”=“0.004”.

The procedure extraction unit 18 displays the procedure having the highest score as the recommended investigation procedure. In FIG. 16B, since the score of procedure model No. 4 is highest as “0.008”, the investigation procedure of procedure model No. 4 is displayed.

When the operator refers to the recommended investigation procedure to input information relating to the actually performed investigation in the event investigation assist device 1, the feedback unit 19 updates the procedure model storage unit 15 and the learning model storage unit 17 based on the input information.

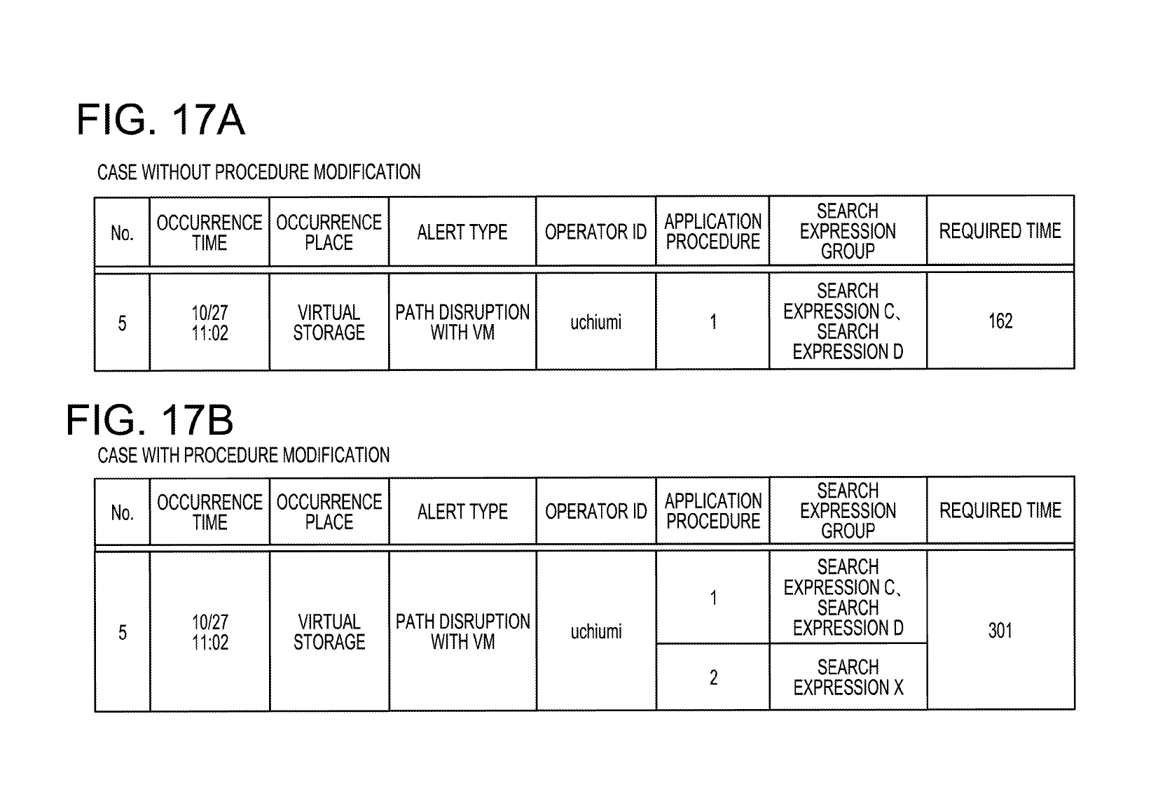

FIGS. 17A and 17B are diagrams illustrating the procedure model added to the procedure model storage unit 15. FIG. 17A illustrates a case without procedure modification, that is, a case where the recommended investigation procedure is used as it is and FIG. 17B illustrates a case with procedure modification.

In FIG. 17A, an investigation procedure using the search expression group “search expression C and search expression D” in the application procedure “1” is added. The investigation procedure using the search expression group “search expression C and search expression D” in the application procedure “1” is the same as the recommended investigation procedure. In FIG. 17B, an investigation procedure using the search expression group “search expression X” in the application procedure “2” is added by using the search expression group “search expression C and search expression D” in the application procedure “1”. When the investigation procedure is compared with the recommended investigation procedure, using the search expression group “search expression X” in the application procedure “2” is added.

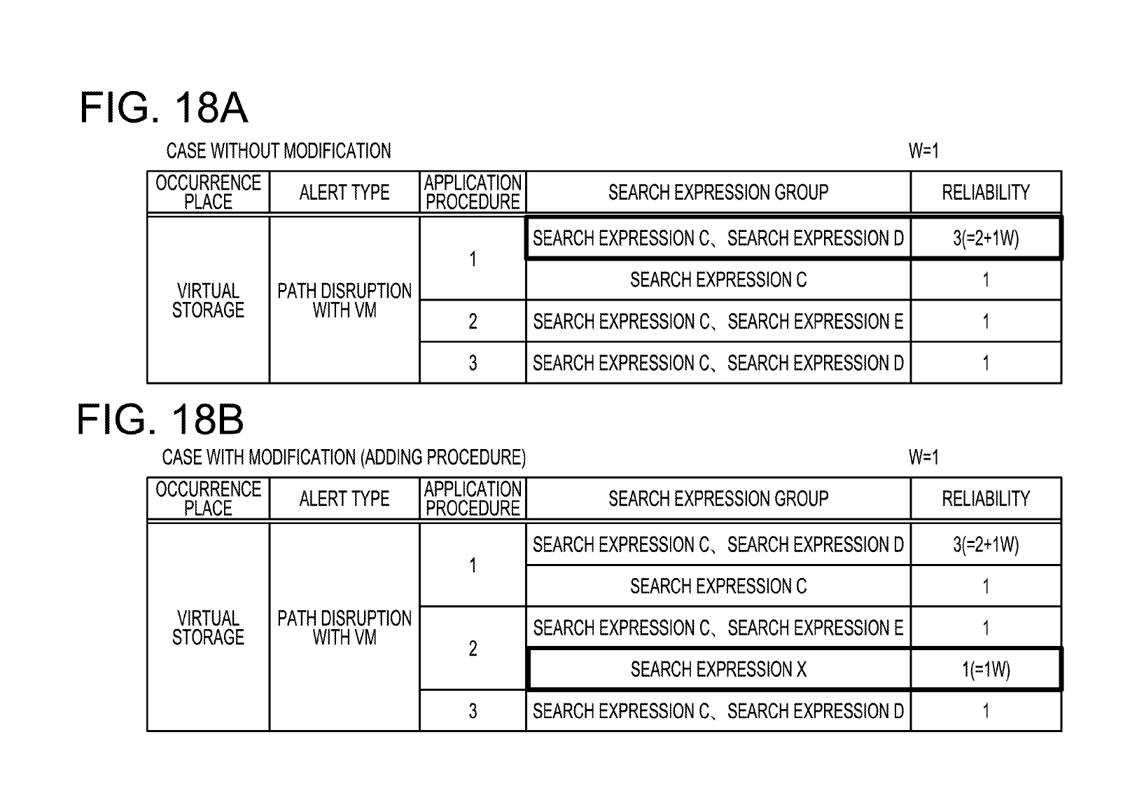

FIGS. 18A and 18B are diagrams illustrating an update result of a learning model. FIG. 18A illustrates a case without modification and FIG. 18B illustrates a case with modification. As illustrated in FIG. 18A, in the case without modification, compared with FIG. 15A, the reliability of the search expression group “search expression C and search expression D” in the application procedure “1” is added with “1” to become “3”. The feedback unit 19 adds a value obtained by multiplying by a weight “W” a degree of importance of the operator's feedback to the reliability of the search expression group “search expression C and search expression D” in the application procedure “1”. Further, here, W=1.

As illustrated in FIG. 18B, in the case with modification, compared with FIG. 15A, the reliability of the search expression group “search expression C and search expression D” in the application procedure “1” is added with “1” to become “3” and the search expression group “search expression X” is added to the application procedure “2” in the reliability “1”.

In FIG. 18B, a case where a search is added is illustrated, but there is insertion or replacement of the search in the modification of the procedure. In the case where insertion or replacement of the search is performed, the feedback unit 19 updates the learning model by adding a negative evaluation to a modified portion of the recommended investigation procedure.

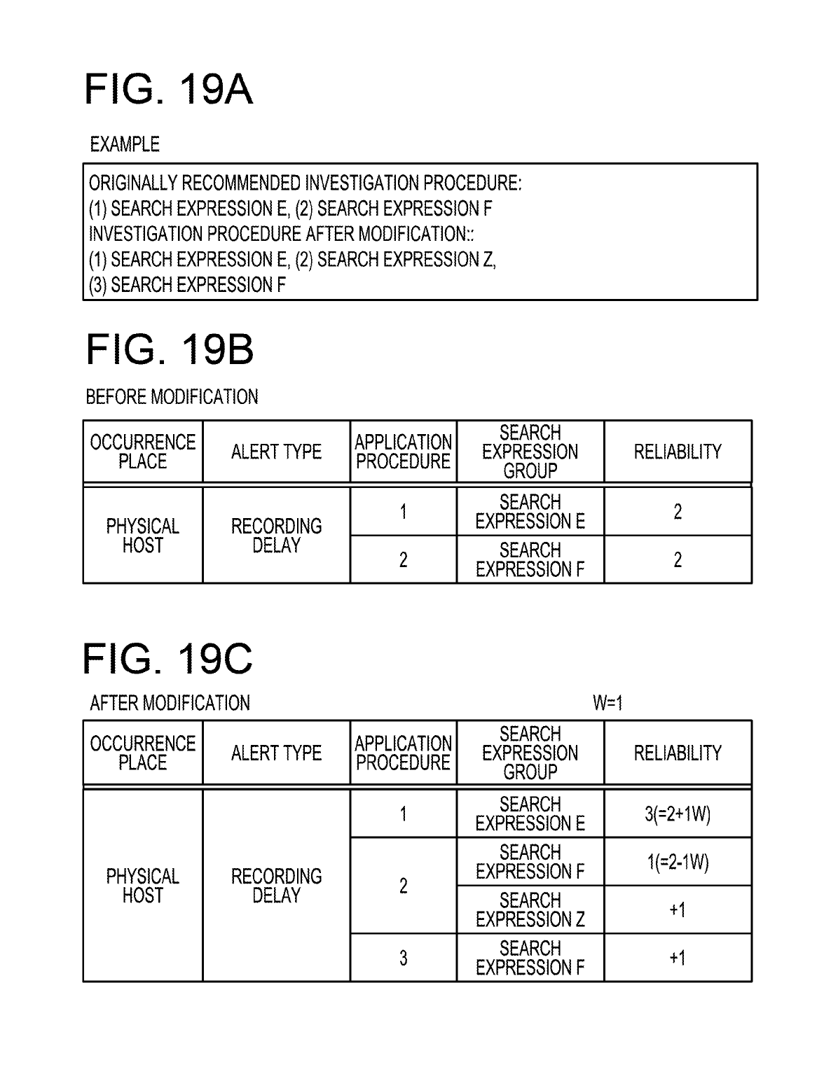

FIGS. 19A to 19C are diagrams for describing a negative evaluation. FIG. 19A illustrates an example of modification, FIG. 19B illustrates the learning model before modification, and FIG. 19C illustrates the learning model after modification. As illustrated in FIG. 19A, in an originally recommended investigation procedure, “search expression E” is used in the application procedure “1” and “search expression F” is used in the application procedure “2”. Meanwhile, in the investigation procedure after modification, “search expression E” is used in the application procedure “1”, “search expression Z” is used in the application procedure “2”, and “search expression F” is used in the application procedure “3”. That is, “search expression Z” is inserted.

As illustrated in FIG. 19B, in the learning model before modification, the reliability of the search expression group “search expression E” in the application procedure “1” is “2” and the reliability of the search expression group “search expression F” in the application procedure “2” is “2”. In addition, when the investigation procedure after modification is added, the reliability of the search expression group “search expression F” in the application procedure “2” is updated from “2” to “1” as illustrated in FIG. 19C. That is, since the procedure model using “search expression Z” in the application procedure “2” is added, the reliability using “search expression F” in the application procedure “2” deteriorates.

As described above, when insertion or replacement of the search is performed, the feedback unit 19 updates the learning model by adding the negative evaluation to the modified portion of the recommended investigation procedure, so that the feedback unit 19 may appropriately reflect the modification of the recommended investigation procedure to the learning model.

As described above, in the first embodiment, the investigation history storing unit 12 stores the alert investigation history extracted from the alert information in the investigation history storage unit 13. In addition, the application procedure estimation unit 14 generates the procedure model using the alert investigation history stored by the investigation history storage unit 13 and stores the generated procedure model in the procedure model storage unit 15. In addition, the search expression reliability calculation unit 16 generates the learning model using the procedure model stored in the procedure model storage unit 15 and stores the generated learning model in the learning model storage unit 17.

The procedure extraction unit 18 acquires the procedure model and the learning model corresponding to the alert class of the occurring alert from the procedure model storage unit 15 and the learning model storage unit 17, respectively, and applies the learning model to each procedure model to calculate the reliability of each procedure model. In addition, the procedure extraction unit 18 calculates the score of each procedure model based on the reliability of each procedure model and the required time, and displays the procedure model with the highest score as the recommended investigation procedure.

Therefore, when the alert occurs, the event investigation assist device 1 may present to the operator an investigation procedure with a higher reliability for acquiring information required for determining whether there is a fault.

In the first embodiment, since the search expression reliability calculation unit 16 generates the learning model based on the number of investigations performed by the procedure model, the number of investigations by the operator may be reflected to the learning model.

In the first embodiment, since the feedback unit 19 updates the procedure model and the learning model based on the investigation procedure actually performed by the operator, the feedback unit 19 may keep the reliabilities of the procedure model and the learning model high.

In the first embodiment, when the search expression group in the application procedure in the investigation procedure actually performed by the operator for the recommended investigation procedure is different from the search expression group in the application procedure in the recommended investigation procedure, the feedback unit 19 reduces the reliability of the search expression group application procedure of the corresponding learning model. Therefore, the feedback unit 19 may keep the reliability of the learning model high.

In the first embodiment, the application procedure estimation unit 14 estimates that the operator refers to the plurality of graphs at the same time and determines that the application procedures of the plurality of search expressions are the same as each other when the time overlapped and displayed among the plurality of graphs is larger than a predetermined threshold value. Therefore, the application procedure estimation unit 14 may reflect the investigation performed by the operator by referring to the plurality of graphs to the procedure model.

### Second Embodiment

However, in the first embodiment, although a case where all operators may trust in the same way has been described, the reliability of the operator is different depending on an experience of the operator, etc. Therefore, in the second embodiment, an event investigation assist device that reflects the reliability of the operator in the learning model will be described.

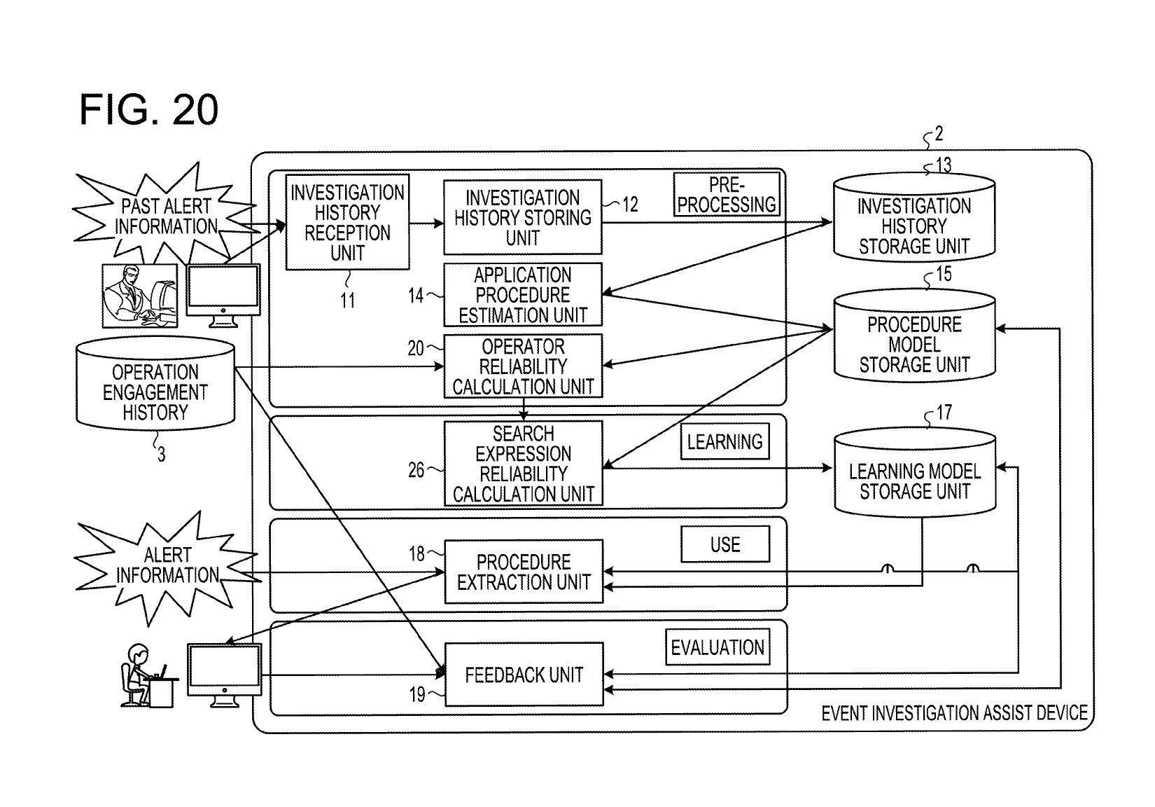

FIG. 20 is a diagram illustrating a functional configuration of an event investigation assist device according to a second embodiment. Further, for the sake of convenience of explanation, the same reference numerals are given to the functional units which play the same roles as the units illustrated in FIG. 2, and a detailed description thereof will be omitted. As illustrated in FIG. 20, an event investigation assist device 2 according to a second embodiment differs from the event investigation assist device 1 illustrated in FIG. 4 in that the event investigation assist device 2 has a search expression reliability calculation unit 26 instead of the search expression reliability calculation unit 16 and newly has an operator reliability calculation unit 20.

The operator reliability calculation unit 20 calculates an operator reliability based on an operation engagement history 3 and transfers the calculated reliability to the search expression reliability calculation unit 26. The operation engagement history 3 is an index representing how much the operator is involved with each component of a server, a storage, a network, or the like of the cloud system.

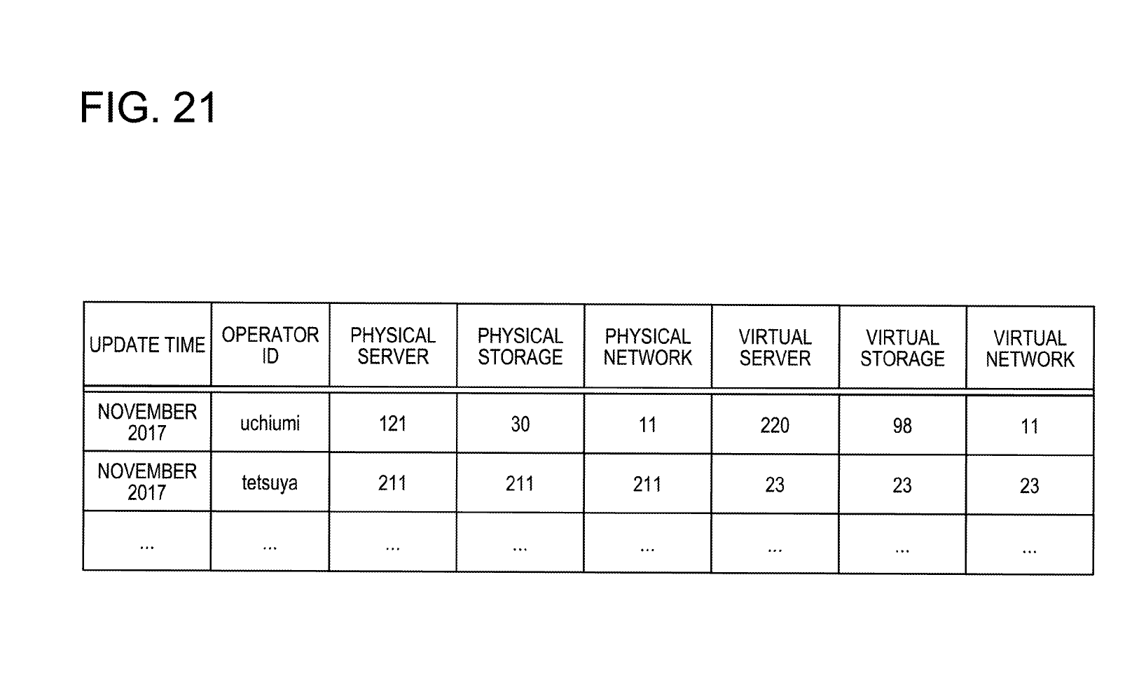

FIG. 21 is a diagram illustrating an example of an operation engagement history 3. As illustrated in FIG. 21, the operation engagement history 3 includes an update time, the operator ID, a physical server, a physical storage, a physical network, a virtual server, a virtual storage, and a virtual network.

The update time is a year and a month when the operation engagement history 3 is updated. The operator ID is an identifier which identifies the operator. The physical server is a time when the operator engages in a task regarding the physical server. The physical storage is a time when the operator engages in a task regarding the physical storage. The physical network is a time when the operator engages in a task regarding the physical network.

The virtual server is a time when the operator engages in a task regarding the virtual server. The virtual storage is a time when the operator engages in a task regarding the virtual storage. The virtual network is a time when the operator engages in a task regarding the virtual network. The units of the physical server, the physical storage, the physical network, the virtual server, the virtual storage, and the virtual network are the time.

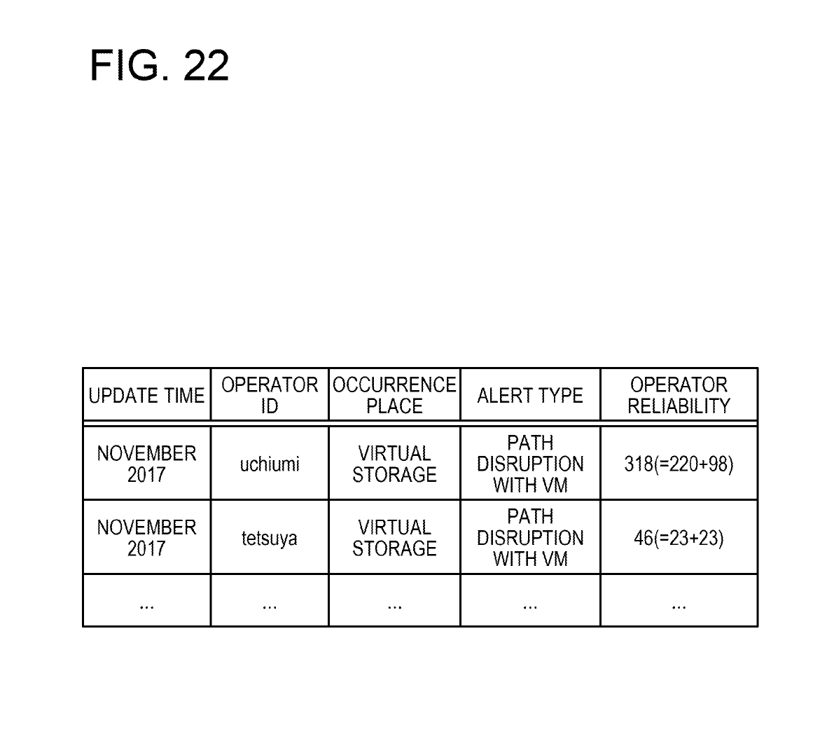

For example, the operator reliability calculation unit 20 adds an engagement time of the component related to the alert class to set the operator reliability. FIG. 22 is a diagram illustrating an operator reliability calculated from the operation engagement history 3 illustrated in FIG. 21. As illustrated in FIG. 22, for example, when the occurrence place of the alert is “virtual storage” and the alert type is “path disruption with VM”, in the calculation of the operator reliability, the engagement time of the virtual server and the virtual storage is used. In FIG. 22, with respect to the alert class in which the occurrence place is “virtual storage” and the alert type is “path disruption with VM”, the operator reliability of “uchiumi” is the engagement time of the virtual server+the engagement time of the virtual storage=220+98=318.

The search expression reliability calculation unit 26 calculates the reliability for each search expression group application procedure with respect to each procedure model for each alert class based on the reliability which the operator reliability calculation unit 20 calculates with respect to each operator, and generates the learning model by using the reliability for each calculated search expression group application procedure.

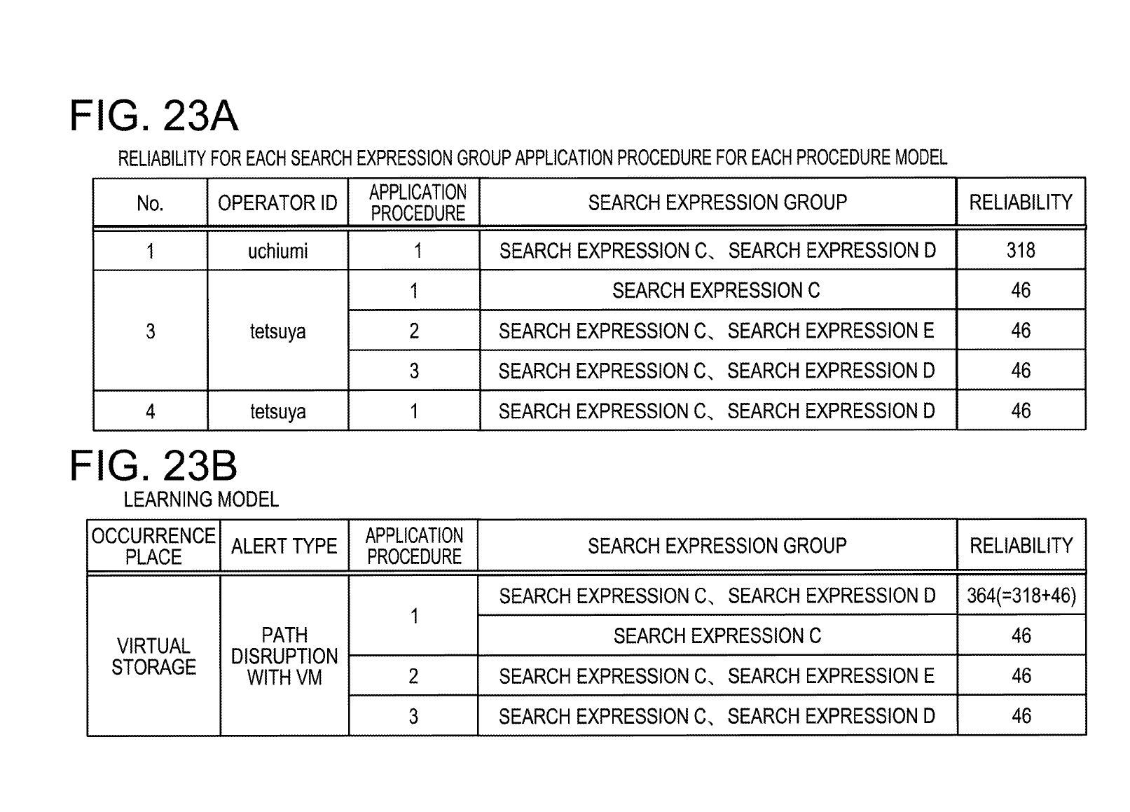

FIGS. 23A and 23B are diagrams illustrating examples of a reliability and a learning model for each search expression group application procedure for each procedure model. FIG. 23A illustrates the reliability for each search expression group application procedure for each procedure model and FIG. 23B illustrates the learning model. As illustrated in FIG. 23A, the reliability for each search expression group application procedure for each procedure model is the operator reliability for each alert class illustrated in FIG. 22. For example, the reliabilities of application procedures “1”, “2”, and “3” of the procedure model “3” are “46” of the operator reliability of “tetsuya” with respect to the alert class in which the occurrence place is “virtual storage” and the alert type is “path disruption with VM”.

As illustrated in FIG. 23B, a value acquired by adding the reliability for each search expression group application procedure to all procedure models is a reliability for each search expression group application procedure in the learning model. For example, the reliability of the search expression group “search expression C and search expression D” in the application procedure “1” of the learning model is the sum of the reliability of the search expression group “search expression C and search expression D” of the application procedure “1” in the procedure model “1” and the reliability of the search expression group “search expression C and search expression D” of the application procedure “1” in the procedure model “4”. That is, the reliability of the search expression group “search expression C and search expression D” in the application procedure “1” of the learning model is “318”+“46”=“364”.

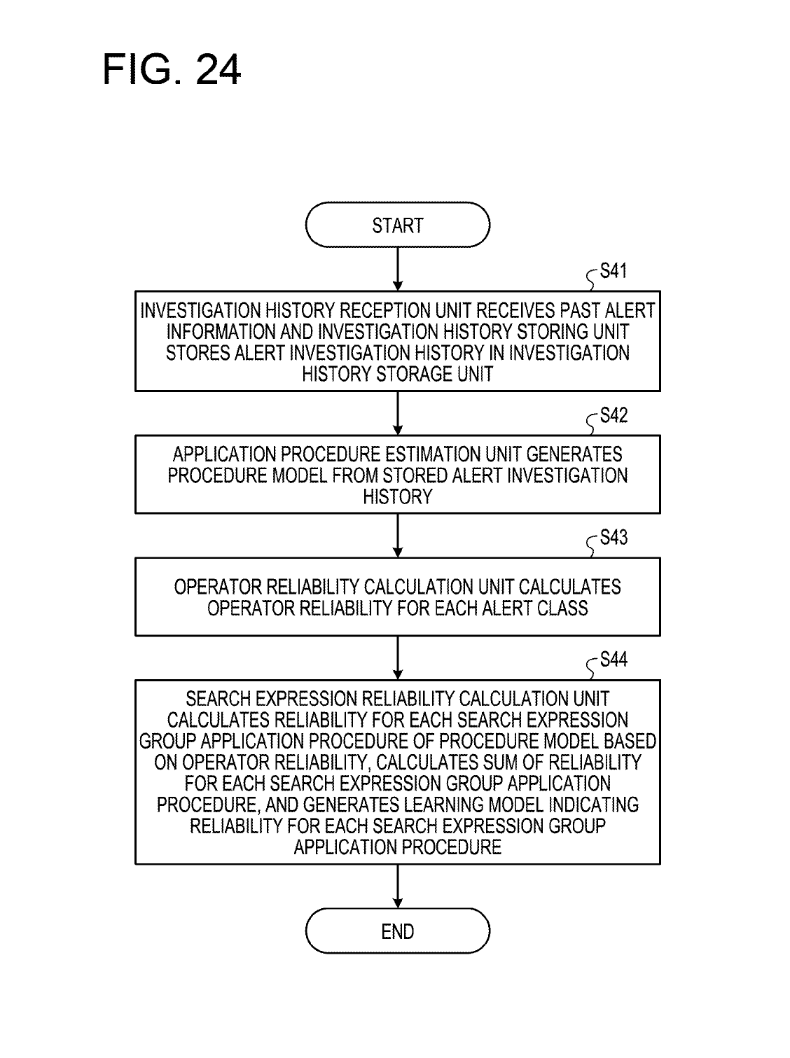

Next, a flow of processing by the event investigation assist device 2 will be described. FIG. 24 is a flowchart illustrating a flow of processing from preprocessing up to learning. Further, a flow of processing from use to evaluation is the same as the flow of the processing by the event investigation assist device 1. As illustrated in FIG. 24, the investigation history reception unit 11 receives the past alert information and the investigation history storing unit 12 stores the alert investigation history in the investigation history storage unit 13 (step S41).

The application procedure estimation unit 14 generates the procedure model from the stored alert investigation history (step S42). Further, the operator reliability calculation unit 20 calculates the operator reliability for each alert class (step S43). In addition, the procedures of the processing of steps S42 and S43 may be reversed. Moreover, the search expression reliability calculation unit 26 calculates the reliability for each search expression group application procedure of the procedure model based on the operator reliability and calculates the sum of the reliability for each search expression group application procedure to generate the learning model indicating the reliability for each search expression group application procedure (step S44).

As described above, the search expression reliability calculation unit 26 calculates the reliability for each search expression group application procedure of the procedure model based on the operator reliability and calculates the sum of the reliability for each search expression group application procedure to generate the learning model. Therefore, the event investigation assist device 2 may generate the learning model based on the reliability of the operator.

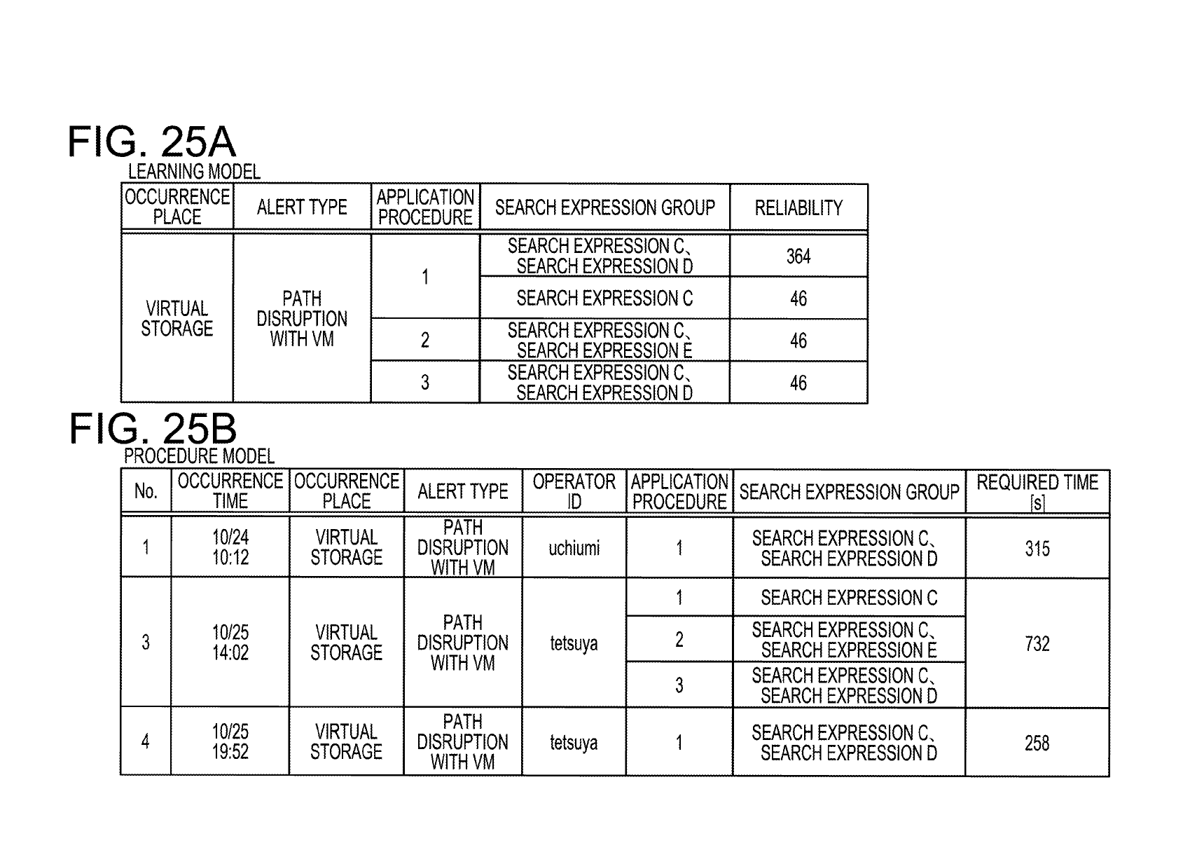

Next, an example by the event investigation assist device 2 will be described with reference to FIGS. 25 to 29. FIGS. 25A and 25B are diagrams illustrating the learning model and the procedure model extracted by the procedure extraction unit 18 of the event investigation assist device 2. FIG. 25A illustrates the learning model and FIG. 25B illustrates the procedure model.

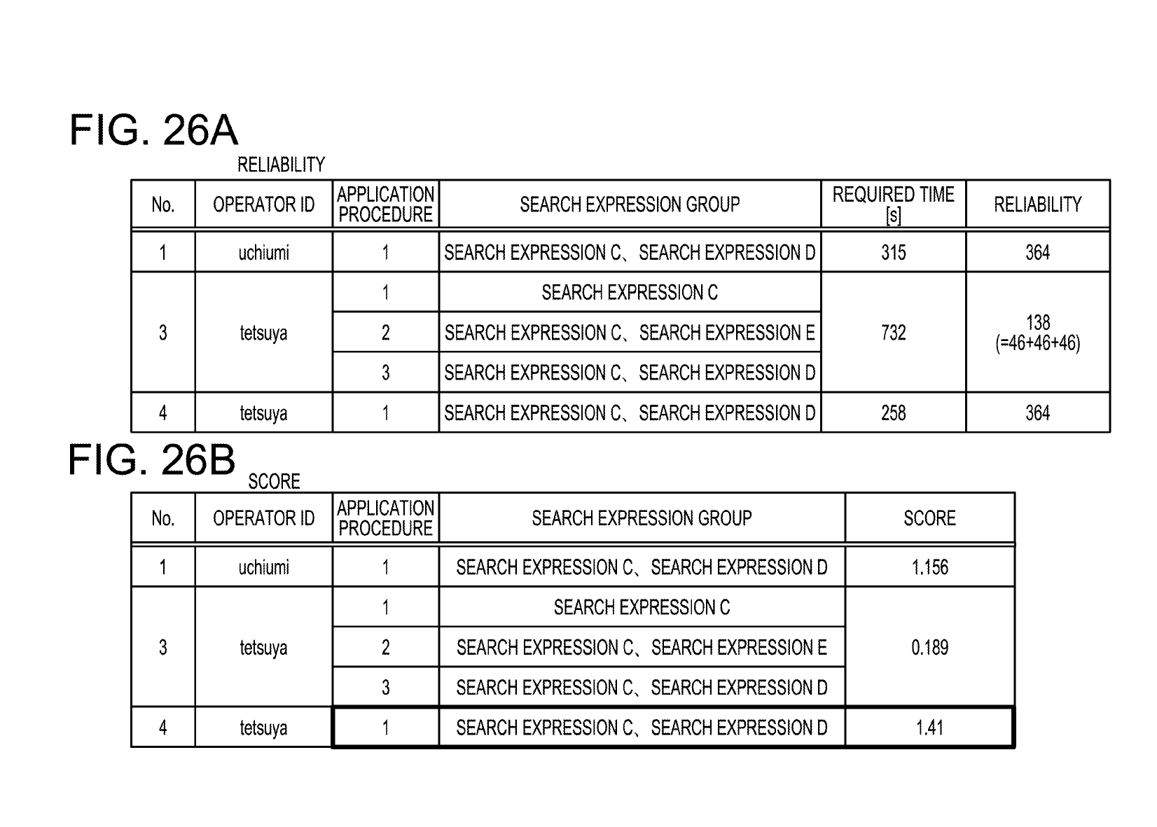

The procedure extraction unit 18 applies the learning model to each procedure model to calculate the reliability of each procedure model and calculates the score of each procedure model by dividing the calculated reliability by the required time. FIGS. 26A and 26B are diagrams illustrating the reliability and the score of the procedure model. FIG. 26A illustrates the reliability and FIG. 26B illustrates the score.

For example, as illustrated in FIG. 25A, the reliability of the search expression group “search expression C” in the application procedure “1” of procedure model “3” is “46” and the reliability of the search expression group “search expression C and search expression E” in the application procedure “2” is “46”. Further, the reliability of the search expression group “search expression C and search expression D” in the application procedure “3” is “46”. Therefore, as illustrated in FIG. 26A, the reliability of the procedure model “3” is “46”+“46”+“46”=“138”. Further, as illustrated in FIG. 26B, the score of the procedure model “3” is “138”/“732”=“0.189”.

The procedure extraction unit 18 displays the procedure having the highest score as the recommended investigation procedure. In FIG. 26B, since the score of procedure model “4” is highest as “1.41”, the investigation procedure of the procedure model “4” is displayed.

When the operator refers to the recommended investigation procedure to input information relating to the actually performed investigation in the event investigation assist device 2, the feedback unit 19 updates the procedure model storage unit 15 and the learning model storage unit 17 based on the input information.

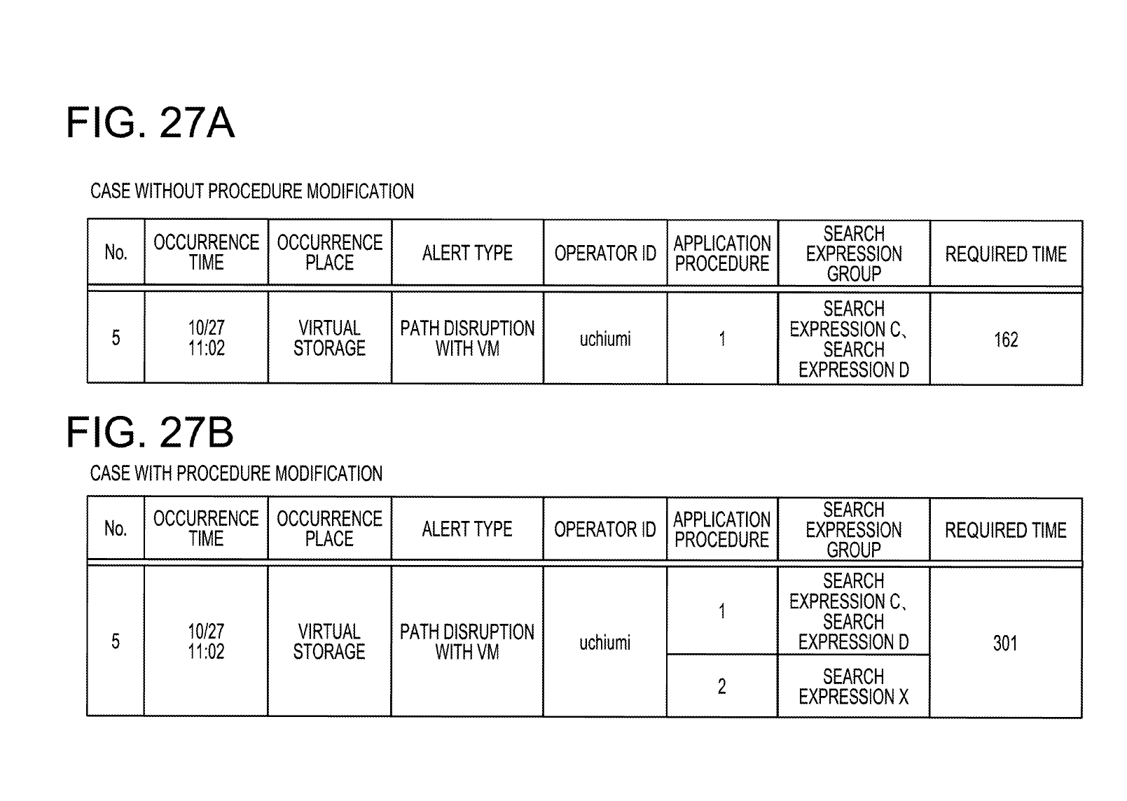

FIGS. 27A and 27B are diagrams illustrating the procedure model added to the procedure model storage unit 15. FIG. 27A illustrates a case without procedure modification, that is, a case where the recommended investigation procedure is used as it is and FIG. 27B illustrates a case with procedure modification.

In FIG. 27A, an investigation procedure using the search expression group “search expression C and search expression D” in the application procedure “1” is added. The investigation procedure using the search expression group “search expression C and search expression D” in the application procedure “1” is the same as the recommended investigation procedure. In FIG. 27B, an investigation procedure using the search expression group “search expression C and search expression D” in the application procedure “1” and using the search expression group “search expression X” in the application procedure “2” is added. When the investigation procedure is compared with the recommended investigation procedure, using the search expression group “search expression X” in the application procedure “2” is added.

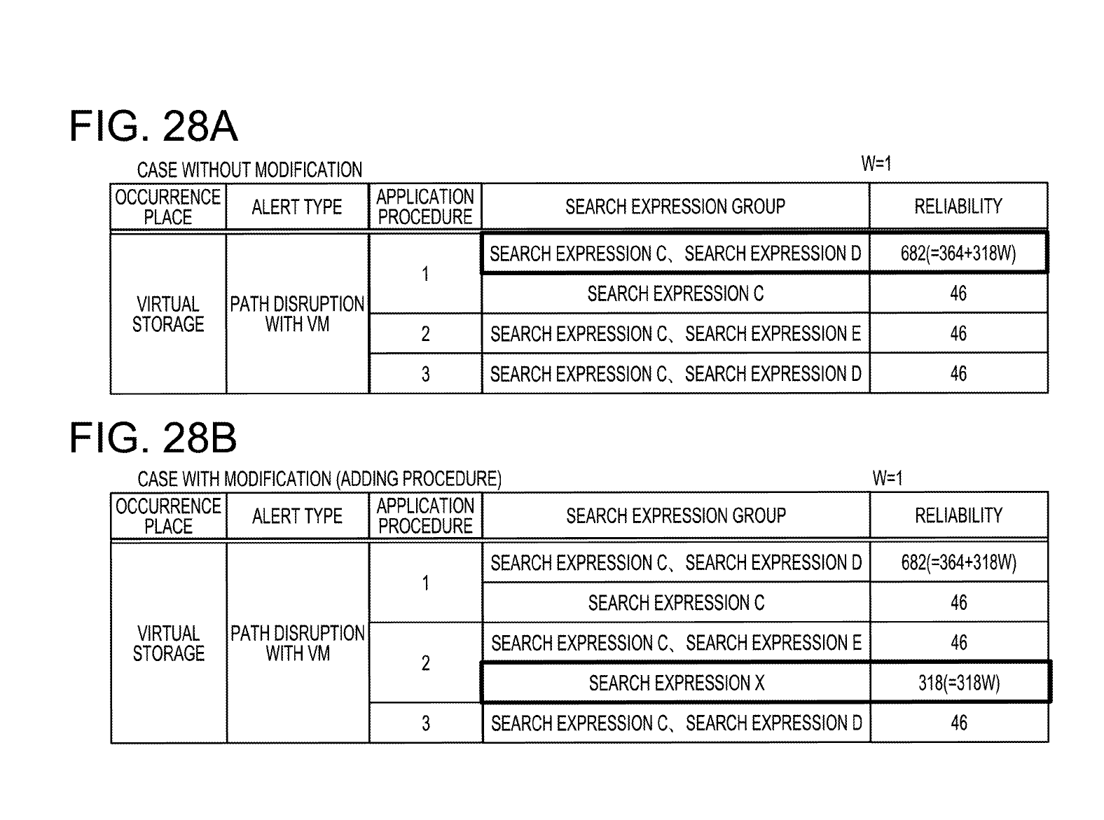

FIGS. 28A and 28B are diagrams illustrating an update result of a learning model. FIG. 28A illustrates a case without modification and FIG. 28B illustrates a case with modification. As illustrated in FIG. 28A, in the case without modification, compared with FIG. 25A, the reliability of the search expression group “search expression C and search expression D” in the application procedure “1” is added with “318” to become “682”. Further, here, W=1.

As illustrated in FIG. 28B, in the case with modification, compared with FIG. 25A, the reliability of the search expression group “search expression C and search expression D” in the application procedure “1” is added with “318” to become “682” and the reliability is “318” and the search expression group “search expression X” is added to the application procedure “2”.

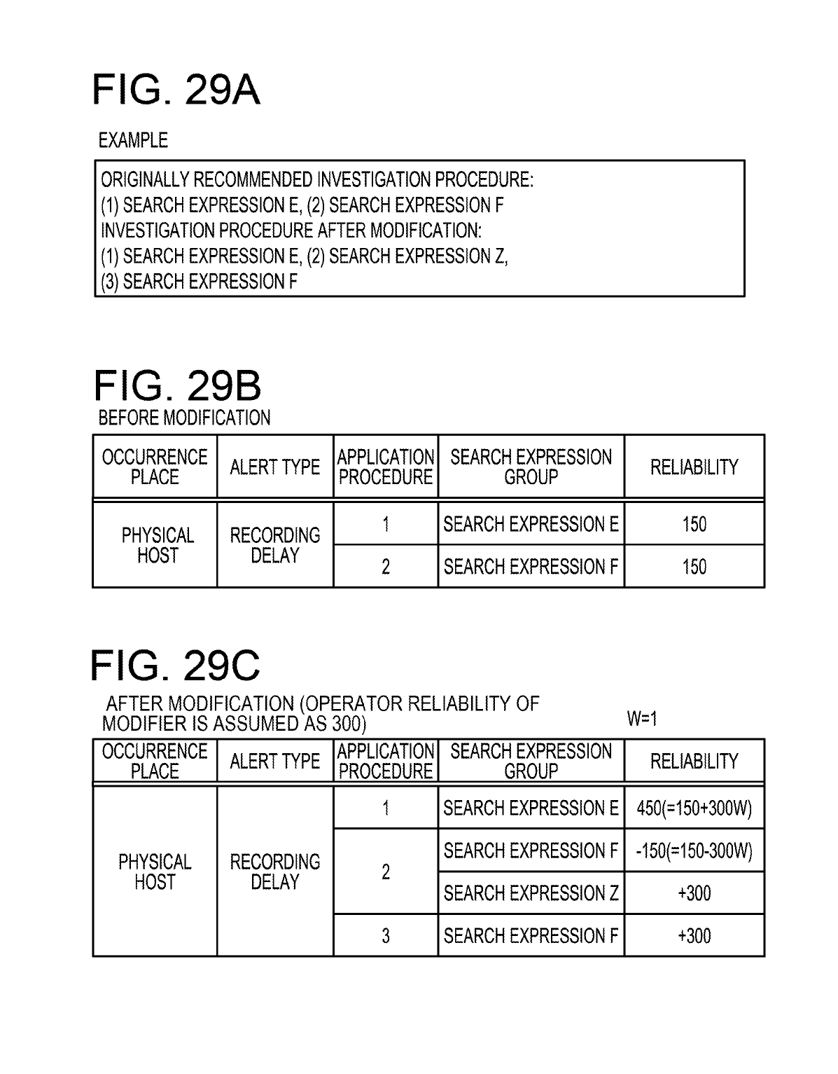

FIGS. 29A and 29B are diagrams for describing a negative evaluation. FIG. 29A illustrates an example of modification, FIG. 29B illustrates the learning model before modification, and FIG. 29C illustrates the learning model after modification. As illustrated in FIG. 29A, in an originally recommended investigation procedure, “search expression E” is used in the application procedure “1” and “search expression F” is used in the application procedure “2”. Meanwhile, in the investigation procedure after modification, “search expression E” is used in the application procedure “1”, “search expression Z” is used in the application procedure “2”, and “search expression F” is used in the application procedure “3”. That is, “search expression Z” is inserted.

As illustrated in FIG. 29B, in the learning model before modification, the reliability of the search expression group “search expression E” in the application procedure “1” is “150” and the reliability of the search expression group “search expression F” in the application procedure “2” is “150”. In addition, when the investigation procedure after modification is added, the reliability of the search expression group “search expression F” in the application procedure “2” is updated from “150” to “−150” as illustrated in FIG. 29C. That is, since the procedure model using “search expression Z” in the application procedure “2” is added, the reliability using “search expression F” in the application procedure “2” deteriorates.

As described above, in the second embodiment, the operator reliability calculation unit 20 calculates the operator reliability for each alert class by using the operation engagement history 3. The search expression reliability calculation unit 26 calculates the reliability for each search expression group application procedure with respect to each procedure model for each alert class based on the reliability which the operator reliability calculation unit 20 calculates with respect to each operator and generates the learning model by using the reliability for each calculated search expression group application procedure. Therefore, the event investigation assist device 2 may display the recommended investigation procedure based on the reliability of the operator.

In the first and second embodiments, the event investigation assist device has been described. However, by implementing the configuration of the event investigation assist device with software, it is possible to obtain an event investigation assist program having the same function. Accordingly, a computer executing the event investigation assist program will be described.

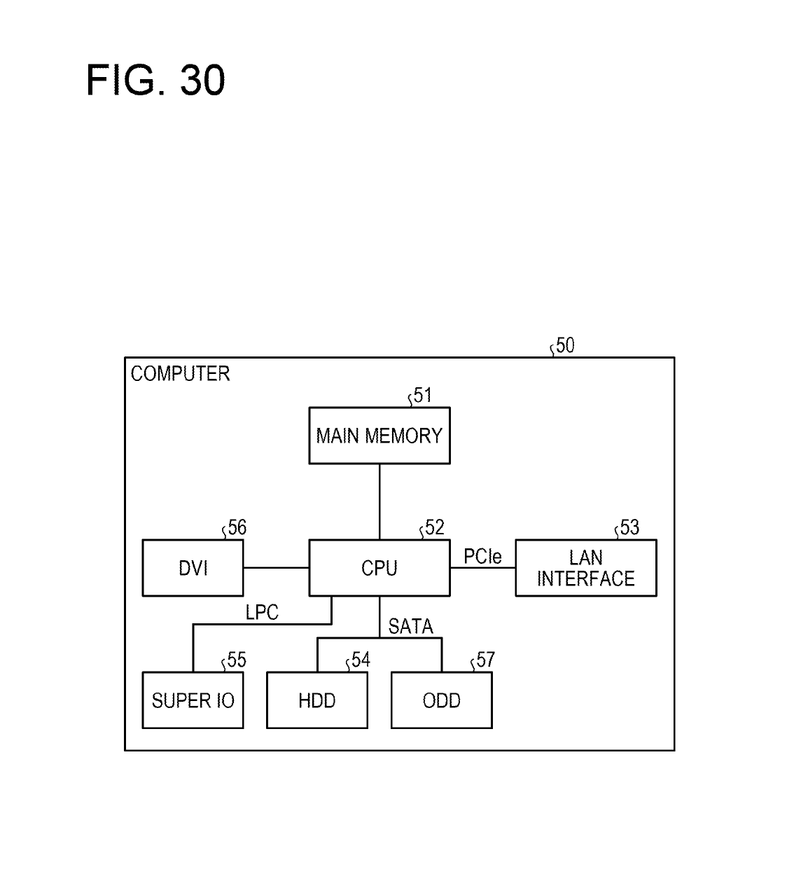

FIG. 30 is a diagram illustrating a hardware configuration of a computer that executes an event investigation assist program according to an embodiment. As illustrated in FIG. 30, a computer 50 includes a main memory 51, a central processing unit (CPU) 52, a local area network (LAN) interface 53, and a hard disk drive (HDD) 54. Further, the computer 50 includes a super input output (10) 55, a digital visual interface (DVI) 56, and an optical disk drive (ODD) 57.

The main memory 51 is a memory that stores a program or a result during the execution of the program. The CPU 52 is a CPU that reads and executes the program from the main memory 51. The CPU 52 includes a chip set having a memory controller.

The LAN interface 53 is an interface which connects the computer 50 to another computer via a LAN. The HDD 54 is a disk device that stores the program or data and the super IO 55 is an interface that connects an input device such as a mouse or keyboard. A DVI 56 is an interface that accesses a liquid crystal display device and an ODD 57 is a device that performs reading and writing of a DVD.

The LAN interface 53 is connected to the CPU 52 by PCI express (PCIe), and the HDD 54 and the ODD 57 are connected to the CPU 52 by serial advanced technology attachment (SATA). The super IO 55 is connected to the CPU 52 by low pin count (LPC).

The event investigation assist program executed in the computer 50 is stored in the DVD as an example of a storage medium readable by the computer 50, read from the DVD by the ODD 57, and installed in the computer 50. Alternatively, the event investigation assist program is stored in the database of another computer system connected via the LAN interface 53 and read from the database and installed in the computer 50. In addition, the installed event investigation assist program is stored in the HDD 54, read by the main memory 51, and executed by the CPU 52.

In the embodiment, the case where it is determined whether there is a fault in the cloud system has been described, but the present disclosure is not limited thereto and the embodiment may be similarly applied to the case where it is determined whether there is a fault in another system.

In the embodiment, the case where the search expression group is used as investigation contents has been described, but the present disclosure is not limited thereto and the embodiment may be similarly applied even to the case where one or more investigation items are investigated as the investigation contents.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process, the process comprising:
storing a procedure model in a memory, the procedure model associating event information with an investigation procedure and a required time for each of events that occur in a system, the event information being information regarding a relevant event, the investigation procedure being a procedure for investigating whether the relevant event is a fault, the required time being a time spent for performing investigation in accordance with the investigation procedure;
storing a learning model in the memory, the learning model associating a first reliability with each of investigation contents for each of the events, the investigation contents being included in the investigation procedure;
accepting first event information; and
calculating a second reliability for each of first investigation procedures based on the learning model and the procedure model, the first investigation procedures being associated with the first event information in the procedure model;
determining a recommended investigation procedure from among the first investigation procedures based on the second reliability and the required time; and
displaying the recommended investigation procedure.

2. The non-transitory computer-readable recording medium according to claim 1, the process further comprising:
generating the procedure model based on information regarding a past event and information regarding an investigation procedure used in investigation performed for the past event; and
generating the learning model based on a number of times of investigation performed by using the procedure model.

3. The non-transitory computer-readable recording medium according to claim 2, the process further comprising:
generating the learning model based on a third reliability and the number of times, the third reliability indicating a reliability of an operator who performs investigation in accordance with the investigation procedure.

4. The non-transitory computer-readable recording medium according to claim 1, the process further comprising:
updating the learning model and the procedure model based on an actual investigation procedure and an actual required time, the actual investigation procedure being an investigation procedure actually performed by an operator in response to the recommended investigation procedure, the actual required time being a time spent for performing investigation in accordance with the actual investigation procedure.

5. The non-transitory computer-readable recording medium according to claim 4, the process further comprising:
lowering the first reliability of each of investigation contents included in the recommended investigation procedure in a case where a relevant investigation content is different from an investigation content included in the actual investigation procedure at a same order as the relevant investigation content in the recommended investigation procedure.

6. The non-transitory computer-readable recording medium according to claim 1, wherein
at least one investigation item included in each of the investigation contents is a search expression of searching a database storing operation information regarding a device included in the system.

7. The non-transitory computer-readable recording medium according to claim 2, wherein
at least two investigation items are included in the investigation contents, and
the process further comprises:
assign a same order to two investigation items included in a same investigation procedure to cause an investigation content at the same order to include the two investigation items in a case where times of displaying respective two display screens for displaying information of the two investigation items overlap for a time larger than a predetermined threshold value.

8. An event investigation assist method, comprising:
storing, by a computer, a procedure model in a memory, the procedure model associating event information with an investigation procedure and a required time for each of events that occur in a system, the event information being information regarding a relevant event, the investigation procedure being a procedure for investigating whether the relevant event is a fault, the required time being a time spent for performing investigation in accordance with the investigation procedure;
storing a learning model in the memory, the learning model associating a first reliability with each of investigation contents for each of the events, the investigation contents being included in the investigation procedure;
accepting first event information; and
calculating a second reliability for each of first investigation procedures based on the learning model and the procedure model, the first investigation procedures being associated with the first event information in the procedure model;
determining a recommended investigation procedure from among the first investigation procedures based on the second reliability and the required time; and
displaying the recommended investigation procedure.

9. An event investigation assist device, comprising:
a memory; and
a processor coupled to the memory and the processor configured to:
store a procedure model in the memory, the procedure model associating event information with an investigation procedure and a required time for each of events that occur in a system, the event information being information regarding a relevant event, the investigation procedure being a procedure for investigating whether the relevant event is a fault, the required time being a time spent for performing investigation in accordance with the investigation procedure;
store a learning model in the memory, the learning model associating a first reliability with each of investigation contents for each of the events, the investigation contents being included in the investigation procedure;
accept first event information; and
calculate a second reliability for each of first investigation procedures based on the learning model and the procedure model, the first investigation procedures being associated with the first event information in the procedure model;
determine a recommended investigation procedure from among the first investigation procedures based on the second reliability and the required time; and
display the recommended investigation procedure.
